(19) United States
(12) Patent Application Publication
(10) Pub. No.: US 2007/0140650 A1
(43) Pub. Date: Jun. 21, 2007

(54) BROADCAST RECEIVING APPARATUS

(75) Inventor: Takaaki SUZUKI, Osaka, NJ (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/612,158

(22) Filed: Dec. 18, 2006

Related U.S. Application Data
(60) Provisional application No. 60/751,315, filed on Dec. 19, 2005.

(51) Int. Cl. H04N 5/91

(52) U.S. Cl. 386/83

(57) ABSTRACT

A broadcast receiving apparatus which can change the operation of a Java application depending on whether a broadcast is being viewed or recorded content is being reproduced. Control information, including first control information which controls startup of the Java application at the time of broadcasting and second control information which controls startup of a Java application that has been recorded into a secondary storage unit, is acquired from a broadcast signal; an AM controls startup of the Java application in accordance with the first control information at the time of broadcasting, and controls startup of the Java application in accordance with the second control information in the case of executing a Java application stored in the secondary storage unit.

### CROSS REFERENCE TO RELATED APPLICATION

This application claims the benefit of U.S. Provisional Application No. 60/751315, filed Dec. 19, 2005, the contents of which are herein incorporated by reference in its entirety.

### BACKGROUND OF THE INVENTION

(1) Field of the Invention

The present invention relates to a broadcast receiving apparatus which accumulates a broadcasted content and reproduces the accumulated content. In particular, the present invention relates to a setup for receiving a content made up of data such as video, audio, and a program that are mutually synchronized, multiplexed with a broadcast wave, and sent, in which the broadcast wave is received and the video, audio, and data is accumulated, as well as a setup for reproducing the content while maintaining synchronization between the video/audio and the data such as a program.

(2) Description of the Related Art

Various content is included in a broadcast signal sent from a broadcast station. Aside from video and audio used in a normal TV program, there are cases where data is included in the content. There are several methods for sending the data, which can be roughly divided into a method of sending the data chronologically and a method of repeatedly sending the data per set interval. In the former method of sending the data chronologically, for example, data that continues over the course of time is sent in sequential order, This method is suitable for sending large amounts of data over a long period of time, but there is a drawback in that data that could not be received due to timing of the send cannot be received again. On the other hand, in the latter method of repeatedly sending the data at a set interval, the same data is repeatedly sent any number of times within a fixed period. This method has an advantage in that during the period when the same data is being sent, any one of the repeatedly-sent pieces of data can be received, and thus the timing of receiving is not limited.

Data broadcast, represented by BML, and file sending through DSMCC data carousel are the examples of this method. It is unknown, particularly in broadcast, when a recipient will select a channel and commence reception. In the method of sending the data chronologically, when the reception is commenced after the send has been performed and thus acquisition of the data fails, the data cannot be re-acquired. Therefore, when sending data such as an application program along with video and audio in the broadcast signal, the method of repeatedly sending the data per set interval is favorable.

At present, specifications for receiving a broadcast signal that includes video, audio, and an application program and executing the application program in synchronization with video and audio, as in the above method, have been developed and are in operation It is possible to receive the sent application program, import the application program into a terminal, and implement various extra functions by executing the application program, rather than simply viewing the video and audio. This method for sending the application program and importing the application program into the terminal is also called “downloading”.

For example, a specification called Digital Video Broadcasting —Multimedia Home Platform (DVB-MHP) ETSIES201812 v1.1.1 (2003-12) has been developed in Europe, and operations according to this specification have already commenced. In addition, the Open Cable Application Platform (OCAP) OC-SP-OCAP 1.0-I16-050803 specification, which provides the same framework in the cable broadcast environment, is being developed in the United States, and actual operations are set to commence. In these specifications, the application program is written in the Java language Various Application Programming Interfaces (APIS) for tuning, graphics display, and the like are provided in the terminal, and the Java application program can control those functions by calling the APIs.

In addition, in North America, the OCAP-DVROC-SP-OCAP-DVR-I02-050524 specification, which aims to adding functions for recording and reproducing the contents in the OCAP specification, is being developed. With this specification, the video, audio, and the Java application program synchronized thereto and executed, which are sent as a cable television broadcast, are recorded as the content, and furthermore, are reproduced in the same manner as when the recorded content are directly reproduced from the broadcast signal. The application program is reproduced in synchronization with the video and audio, in the same manner as direct reproduction from the broadcast signal.

Moreover, with OCAP-DVR, trick-play of the content is realized by recording broadcast content to a high-speed randomly accessible storage medium, such as a hard disk, a solid-state memory, and the like. Here, the trick-play refers to functions for reproducing the contents at an arbitrary speed, from an arbitrary position, and so on, such as fast-forward, rewind, slow-motion, pause, skip, and the like. With OCAP-DVR, the application program imported into the terminal from the broadcast wave can control the recording and trick-play of the content. In other words, APls for recording and trick play are provided in the terminal, and the Java application program controls each function by calling those APIs.

Reproduction of recorded content generated in this manner basically aims to recreate a broadcast. The original aim of recording a broadcast signal is to allow broadcasted content that cannot be viewed in real time to be viewed at a time convenient for the user. Therefore, it is normally necessary for the content recorded into the recording device to reproduce the exact same details that were broadcasted.

However, there are cases in which, to attain a certain specific goal, the details of the broadcasted content at the time of reproduction are changed when reproducing the recorded content in which the broadcasted content has been recorded. The replacement of commercials can be given as an example. In general, commercials are inserted in between TV programs, and there are many cases where commercials related to products that fit the time slot and details of the TV program being broadcast are inserted in order to heighten the effectiveness of the advertisement. For example, commercials for soft drinks are frequently used in the summer, and during baseball game broadcasts, commercials for baseball-related goods are used. However, when, for example, a commercial that has a significant advertising power when broadcast in the summer is recorded, that advertisement loses much of its power if it is reproduced in the winter. For this reason, it would be possible to provide more effective advertising if the commercials inserted into TV programs contained in recorded content could be changed to “commercials appropriate for the season”.

The document “Japanese Laid-Open Patent Application No. 2003-163850” implements a method for replacing commercials. With the method of this document, the date and time of reproduction is acquired when recorded content is to be reproduced, commercials appropriate for that date and time are acquired from a server, and the original commercials are replaced.

As in the example found in the aforementioned document, it can be thought that there will be a continuing need to broadcast already-recorded content in a different form than that found in the original broadcast. For example, in an environment in which a Java program is executed, such as MHP and OCAP, a Java program that accompanies content to be reproduced is started at the time of the broadcast. Therefore, regarding the recorded content, starting the Java program that accompanies that content is the proper course of action to take, considering that the broadcast is to be completely recreated.

However, there are certain requirements regarding Java programs which, for example, are not started during broadcast/viewing but are started when content that has already been recorded is reproduced, or Java programs which, conversely, are started during broadcast/viewing but are not to be started when content that has already been recorded is reproduced.

A Java program that implements digest broadcasting can be given as an example of the former. With live broadcasting of a sports game, while it is impossible to predict beforehand what sort of scenes will characterize the game, it is possible to record the game and view a digest of the game when reproducing the recorded game after it has finished, as scenes that characterize the game, such as a certain team scoring, are already known. The aforementioned OCAPDVR provides, for a Java program, a “function for reproducing recorded AV from the desired point in time”; therefore, digest reproduction can be implemented by using a Java program which acquires time information of scenes of value to digest reproduction from a server. There is no reason to start such an application during a live broadcast, and so the application does not need to be started.

In addition, a Java application which allows viewers to enjoy a quiz, which features prizes, that is interrelated with a game show can be given as an example of the latter. This Java program is started while the game show is being broadcast; viewers can solve the same problems that are presented to the contestants, and in the case where the viewer has accumulated a high final score, he or she can receive a prize. In such a case, the viewer's answers to all the questions are found when broadcasting of the TV program has ended, and therefore using this application for recorded content may result in the viewer solving every problem correctly, and thus the original purpose of the application cannot be fulfilled.

In the current state of publicly-known technology, there is no means for judging whether or not to start a Java program when reproducing recorded content and when viewing a broadcast. For example, when the technology of the abovementioned document is applied in a broadcast receiving apparatus, where the apparatus confirms the present time reproducing recorded content and prohibits the Java program from starting in the case where the confirmed time differs to an extent from the time of the original broadcast, it is not possible to start, during recorded content reproduction, a Java program to be started both during broadcast viewing and during recorded content reproduction.

Accordingly, a goal of the present invention, which has been conceived in light of the aforementioned problems, is to provide a broadcast receiving apparatus which changes the operation of a program depending on whether a broadcast is being viewed or recorded content is being reproduced.

### SUMMARY OF THE INVENTION

To achieve the aforementioned goal, the broadcast receiving apparatus according to the present invention includes: a receiving unit which receives a broadcast signal that includes a broadcast service, the broadcast service including video and audio information, an application program, and control information for controlling startup of the application program; a video and audio reproduction unit which reproduces the video and audio information included in the broadcast service; an application extraction unit which extracts the application program, the application program being executed in synchronization with the video and audio information reproduced by the video and audio reproduction unit; an application execution unit which executes the application program included in the broadcast service in accordance with the control information included in the broadcast service; a secondary storage unit which has an area that stores information even when the power source to the broadcast receiving apparatus is cut off; and a recording unit which records the broadcast service including the video and audio information and application program into the secondary storage unit. The control information includes first control information for controlling startup of the application program at the time of broadcasting, and second control information for controlling, after the application program has been recorded into the secondary storage unit, startup of the recorded application program; the application execution unit controls startup of the application program associated with the first control information in accordance with the first control information, at the time of broadcasting; and the application execution unit controls startup of the application program in accordance with the second control information associated with the application program, in the case of executing an application program that has been recorded into the secondary storage unit.

Through this, it is possible to control the startup of an application program depending on whether a broadcast is being viewed or recorded content is being reproduced, by adding information to the application signal.

Note that in environments such as MHP and OCAP, an application signal that implements “in what manner the Java program should be started” is sent at the same time as the Java program, and the receiving terminal controls the startup of the Java program by receiving that signal. In, for example, the MHP and OCAP environments, this signal is called an Application Information Table (AIT).

With the present invention, the operation of a Java program can be changed depending on whether a broadcast is being viewed or recorded content is being reproduced, by adding information to the application signal.

In addition, during reproduction by the video and audio reproduction unit, in the case where the application extraction unit extracts the application program recorded into the secondary storage unit, the application extraction unit may extract the application program for which the second control information, which is included in the control information recorded into the secondary storage unit, indicates the application is to be started automatically.

Through this, it is possible to cause the appropriate application program to start when recorded content is reproduced.

Furthermore, during reproduction by the video and audio reproduction unit, in the case where the application extraction unit extracts the application program recorded into the secondary storage unit, the application extraction unit may extract the application program for which the second control information and the first control information, which are included in the control information recorded into the secondary storage unit, indicate the application is to be started automatically.

Through this, when reproducing recorded content, it is possible to start the same application program as is started at the time of viewing a broadcast.

It should be noted that the present invention may be implemented not only as the abovementioned broadcast receiving apparatus, but also as a method and program through which the broadcast receiving apparatus receives a broadcast, and as a storage medium in which that program is stored.

### FURTHER INFORMATION ABOUT TECHNICAL BACKGROUND TO THIS APPLICATION

The disclosure of U.S. Provisional Application No. 60/751315, filed Dec. 19, 2005, including specification, drawings, and claims, is incorporated herein by reference in its entirety.

### BRIEF DESCRIPTION OF THE DRAWINGS

These and other objects, advantages, and features of the invention will become apparent from the following description thereof taken in conjunction with the accompanying drawings that illustrate a specific embodiment of the present invention. In the drawings:

FIG. 1 is a configuration diagram of a broadcast system according to the present invention;

FIG. 2 is a diagram showing one example of use of a frequency band used in communications between a system on the broadcast station side and a terminal apparatus, in a cable television system according to the present invention;

FIG. 3 is a diagram showing one example of use of a frequency band used in communications between a system on the broadcast system side and a terminal apparatus, in a cable television system according to the present invention;

FIG. 4 is a diagram showing one example of use of a frequency band used in communications between a system on the broadcast system side and a terminal apparatus, in a cable television system according to the present invention;

FIG. 5 is a configuration diagram of a TS packet predefined by MPEG-2 specifications;

FIG. 6 is a schematic diagram of an MPEG-2 transport stream;

FIG. 7 is a diagram showing an example of division when a PES packet predefined by the MPEG-2 specifications is transmitted using a TS packet;

FIG. 8 is a diagram showing an example of division when an MPFG-2 section predefined by MPEG-2 specifications is transmitted using a TS packet;

FIG. 9 is a configuration diagram of an MPEG-2 section predefined by MPEG-2 specifications;

FIG. 10 is a diagram showing an example of use of an MPEG-2 section predefined by MPEG-2 specifications;

FIG. 11 is a diagram showing an example of use of a PMT predefined by MPEG-2 specifications;

FIG. 12 is a diagram showing an example of use of a PAT predefined by MPEG-2 specifications;

FIG. 13 is a configuration diagram showing an example of a hardware configuration of a broadcast receiving apparatus according to the present invention;

FIG. 14 is a diagram showing an example of a front panel of an input unit in a hardware structure of a broadcast receiving apparatus according to the present invention;

FIG. 15 is a diagram showing an example of data flow among hardware of the broadcast receiving apparatus according to the present invention;

FIG. 16 is a diagram showing an example of data flow among hardware of the broadcast receiving apparatus according to the present invention;

FIG. 17 is a diagram showing a structure of the program stored in a broadcast receiving apparatus according to the present invention;

FIG, 18 is a diagram showing an example of channel information;

FIG. 19 is a diagram showing a structure of a recording manager according to the present invention;

FIG. 20 is an example of a recording information management table managed by the recording manager according to the present invention,

FIG. 21 is a diagram showing a structure of an AM according to the present invention;

FIG. 22 is an example of an AIT according to the first embodiment of the present invention;

FIG. 23 is a flowchart showing an operation performed by an application status management unit at the time of reproducing a broadcast service according to the first embodiment of the present invention;

FIG. 24 is a flowchart showing an operation performed by an application status management unit at the time of reproducing a recorded service according to the first embodiment of the present invention;

FIG. 25 is a schematic diagram showing a file system sent in DSMCC format according to the present invention;

FIG. 26 is a diagram showing an example of an EPG screen display;

FIG. 27 is a diagram showing an example of an EPG screen display;

FIG. 28 is an example of an AIT according to the second embodiment of the present invention;

FIG. 29 is a flowchart showing an operation performed by an application status management unit at the time of reproducing a recorded service according to the second embodiment of the present invention;

FIG. 30 is an example of an AIT according to the third embodiment of the present invention;

FIG. 31 is a flowchart showing an operation performed by an application status management unit at the time of reproducing a broadcast service according to the third embodiment of the present invention; and

FIG. 32 is a flowchart showing an operation performed by an application status management unit at the time of reproducing a recorded service according to the third embodiment of the present invention.

### DESCRIPTION OF THE PREFERRED EMBODIMENTS

### First Fmbodiment

Hereafter, an apparatus and a method according to the first embodiment of the present invention shall be described with reference to the drawings. The present invention is aimed at recording and reproduction of a content sent and received with an arbitrary medium; however, in the present embodiment, a cable television broadcast system is described as an example. In the cable television broadcast system, a broadcast recording and reproduction apparatus, as in the present invention, is generally called a terminal apparatus.

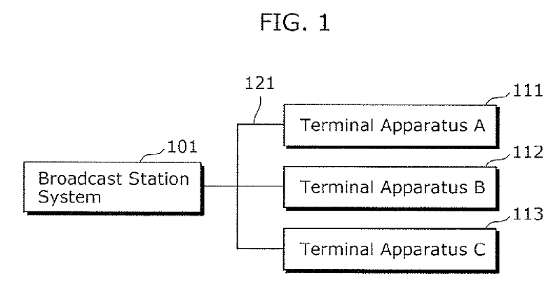

FIG. 1 is a block diagram showing a relationship of apparatuses that make up a broadcast system; the broadcast system is made up of a broadcast station system 101, a terminal apparatus A111, a terminal apparatus B112, and a termninal apparatus C113. A coupling 121 between the broadcast station system and each terminal apparatus is, in the cable system, a wired coupling such as a coaxial cable, a fiber-optic cable, and the like. In FIG. 1, one broadcast station system is coupled with three terminal apparatuses, but any number of terminal apparatuses may be used.

The broadcast station system 101 sends information such as video/audio/data for data broadcast in a broadcast signal to a plurality of terminal apparatuses. The broadcast signal is sent using a frequency within a frequency band set by an operational default of the broadcast system, the laws of a country/region in which the broadcast system is operated, and so on.

With the cable system in the present embodiment, the frequency band used in broadcast signal transmission is divided into the data details and transmission direction (inbound, outbound) and applied.

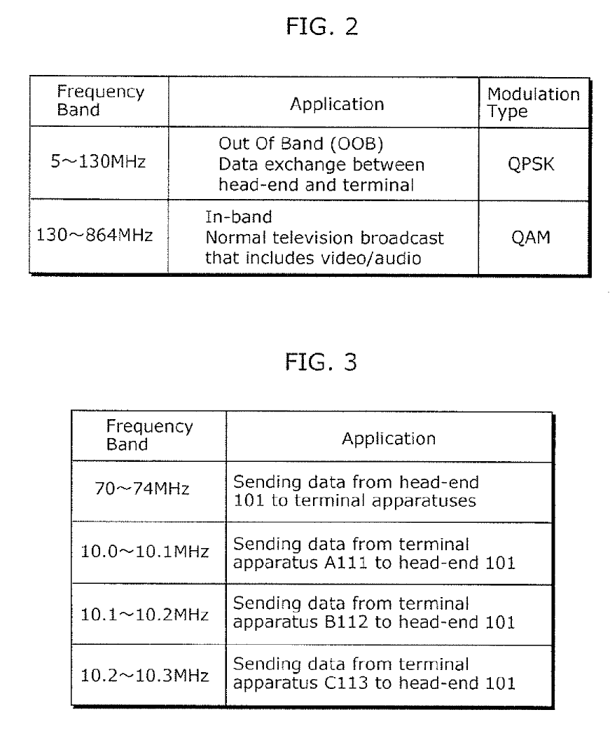

FIG. 2 is a table showing an example of divided frequency bands. The frequency bands can be roughly divided into two types: Out of Band (abbr. OOB) and In-Band. 5 MHz to 130 MHz is assigned as OOB, and is mainly used in data exchange between the broadcast station system 101 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation type is used with COB, and QAM64 or QAM256 modulation type is used with In-Band. A detailed explanation of modulation techniques shall be omitted here, since they are publicly known techniques which are of little relation to the present invention.

FIG. 3 is one example of a more detailed use of the OOB frequency band. 70 MHz to 74 MHz is used in outbound data sending from the broadcast station system 101, and each of the terminal apparatus A111, B112, C113 receives the same data from the broadcast station system 101. On the other hand, 10.0 MHz to 10.1 MHz is used in inbound data sending from the terminal apparatus A111 to the broadcast station system 101; 10.1 MHz to 10.2 MHz is used in inbound data sending from the terminal apparatus B112 to the broadcast station system 101; and 10.2 MHz to 10.3 MHz is used in inbound data sending from the terminal apparatus C113 to the broadcast station system 101. Through this, it is possible for each of the terminal apparatuses A111, B112, and C113 to independently send data unique to that terminal apparatus to the broadcast station system 101.

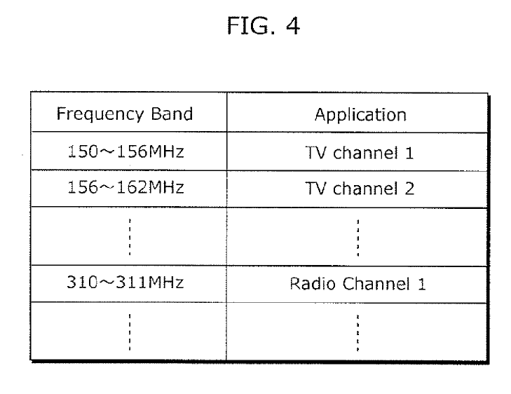

FIG. 4 shows an example use of the In-Band frequency band. Frequency bands of 150 to 156 MHz and 156 to 162 MHz are allocated to television channels 1 and 2 respectively; television channels are allocated in 6 MHz intervals thereafter. 310 MHz and the subsequent frequencies are allocated to radio channels in 1 MHz units. Each of the above channels may be used either for analog broadcasting or digital broadcasting. Digital broadcast is sent in TS packet format in accordance with the MPEG-2 specifications, and in addition to audio and video, it is also possible to send data for various data broadcast and TV program composition information for configuring an EPG.

The broadcast station system 101 uses the frequency bands described above to send an appropriate broadcast signal to the terminal apparatuses, and therefore has a QPSK modulation unit, a QAM modulation unit, and so on. In addition, the broadcast station system 101 has a QPSK demodulator for receiving data from the terminal apparatuses. Moreover, the broadcast station system 101 is can be thought of as having various devices related to the modulation units and the demodulation unit. However, detailed explanations of these shall be omitted here, since the present invention is mainly related to the terminal apparatuses.

The terminal apparatuses A111, B112, and C113 each have a QAM demodulation unit and a QPSK demodulation unit in order to receive and reproduce a broadcast signal from the broadcast station system 101. In addition, each terminal apparatus has a QSPK modulation unit in order to send data, which is unique to each terminal apparatus, to the broadcast station system 101. In the present invention, the terminal apparatuses are broadcast recording and reproduction apparatuses, and detailed configurations shall be described later

The broadcast station system 101 modulates an MPEG-2 transport stream and transmits the stream within the broadcast signal. A terminal apparatus receives the broadcast signal, demodulates and reproduces the MPEG-2 transport stream, extracts necessary information from the stream, and uses that information. In order to describe device functions and connection structures present in the terminal apparatus, the structure of the MPEG-2 transport stream shall first be described in simple terms.

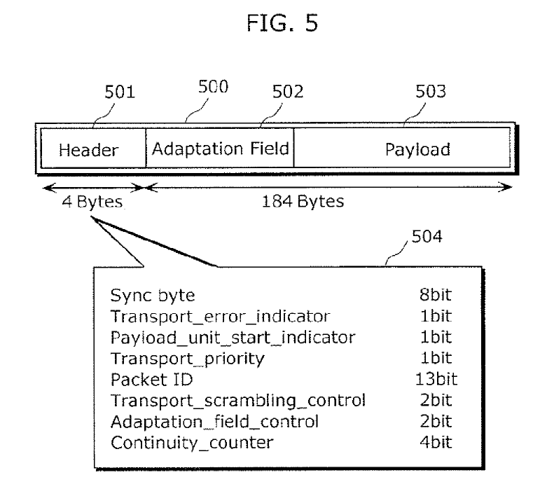

FIG. 5 is a diagram showing the structure of a TS packet. A TS packet 500 has a length of 188 bytes, and is composed of a header 501, an adaptation field 502, and a payload 503. The header 501 holds control information of the TS packet, has a length of 4 bytes, and is structured as shown in 504. In the header 501 there is a field denoted as “Packet ID” (hereafter, PTD), and the TS packet is identified through the value of this PID. The adaptation field 502 holds additional information such as time information. The adaptation field 502 is not mandatory, and there are cases where the adaptation field 502 is not present. The payload 503 holds information transmitted by the TS packet, such as video, audio, and data used for data broadcast.

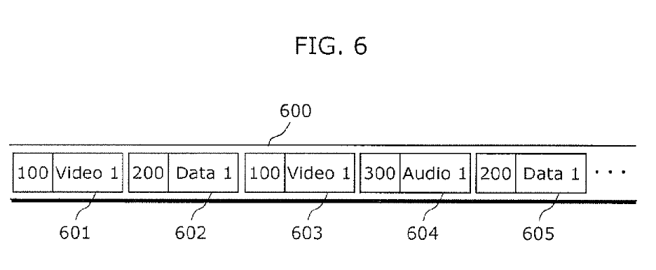

FIG. 6 is a schematic diagram of an MPEG-2 transport stream. The TS packet holds various information in the payload, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a series in sequence is called multiplexing. An MPEG-2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV program composition information, by receiving multiplexed TS packets and extracting, per PID, the information that the TS packet holds. In FIG. 6, the TS packet 601 and the TS packet 603 each transmit information regarding the video 1, and the TS packet 602 and the TS packet 605 each transmit information regarding the data 1.

Here, description shall be given regarding a format of each type of data contained in the payload.

Video and audio are expressed by a format called a Packetized Elementary Stream (PES) packet. The PES packet includes video information or audio information of a certain time period, and by receiving the PES packet, the broadcast recording and reproduction apparatus can output the video and audio information contained in that PES packet to a display and a speaker. The broadcast station transmits the PES packets without pause, and therefore it is possible for the broadcast recording and reproduction apparatus to continuously reproduce the video and audio without pause. When the PES packet is actually transmitted, it is divided and stored in the payloads of a plurality of TS packets in the case where the PES packet has a size larger than that of the payload of one TS packet.

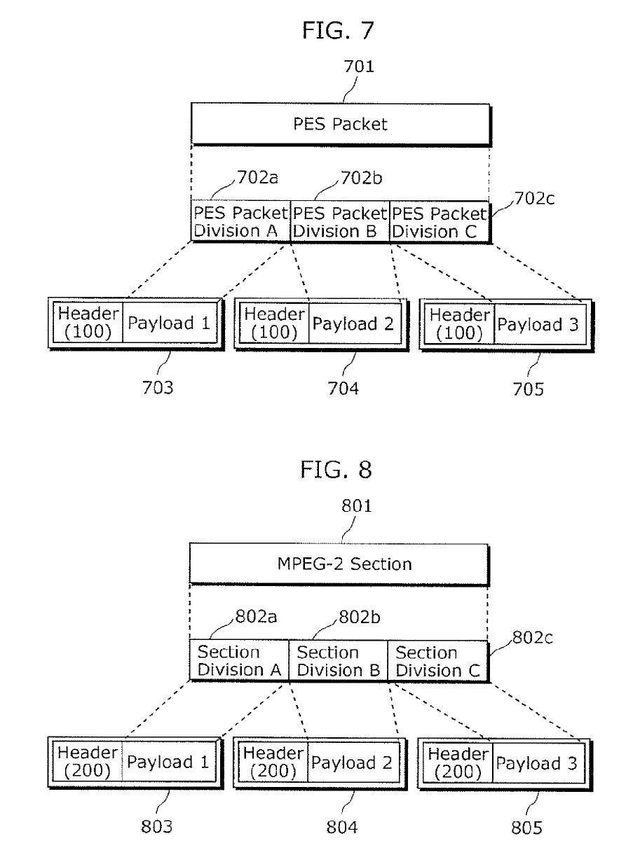

FIG. 7 shows an example of division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is transmitted by three TS packets 703 to 705 which have identical PIDs. In actuality, the video and audio is obtained as an elementary stream (ES) that is obtained by concatenating data contained in the payloads of a plurality of PES packets. The format of this elementary stream is digitalized video and audio, such as defined by the MPEG-2 Video standard, the MPEG-1 and 2 Audio standard, and the like.

On the other hand, information such as the TV program composition information and data used for data broadcast is expressed using a format called an MPEG-2 section. When the MPFG-2 section is actually transmitted, the MPEG-2 section is divided and stored in the payloads of a plurality of TS packets in the case where the MPEG-2 section has a size larger than the payload of one TS packet.

FIG. 8 shows an example of division when the MPEG-2 section is transmitted. As an MPEG-2 section 801 is too large to be stored and transmitted in a payload of a single TS packet, the MPEG-2 section 801 is divided into a section division A 802a, a section division B 802b, and a section division C 802c, and is transmitted by three TS packets 803 to 805 which have identical PIDS.

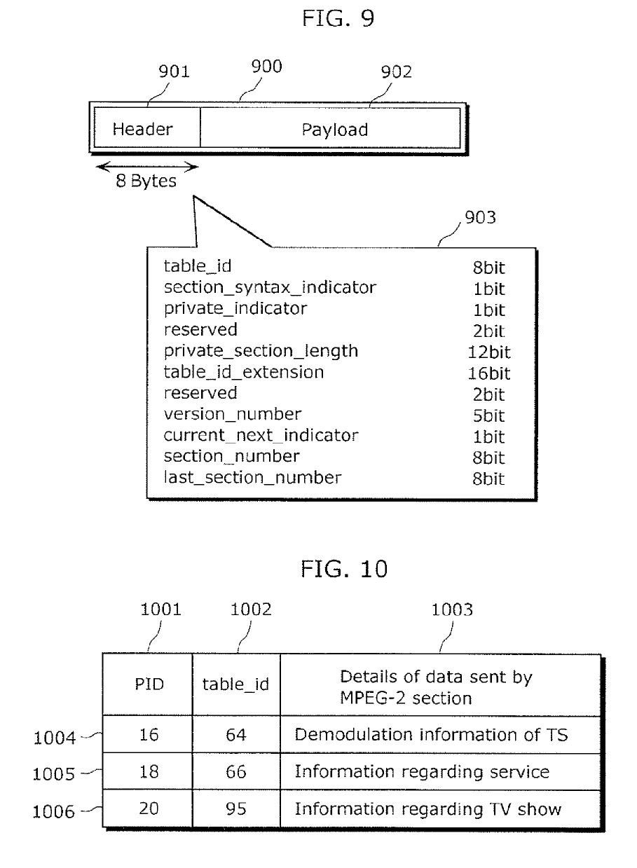

FIG. 9 expresses a structure of the MPEG-2 section. An MPEG-2 section 900 is configured of a header 901 and a payload 902. The header 901 holds control information of the MPEG-2 section. That configuration is expressed by a header configuration 903. The payload 902 holds data transmitted by the MPEG-2 section 900. A table_id present in the header configuration 903 expresses the type of the MPEG-2 section, and a table_id_extension is an extension identifier used when further distinguishing between MPEG-2 sections with identical table_ids.

The case where the TV program composition information is transmitted, as in FIG. 10, can be given as an example of use of the MPEG-2 section. In this example, as written in row 1004, information necessary for demodulating the broadcast signal is denoted in the MPEG-2 section which has a table_id of 64 in the header structure 903; furthermore, this MPEG-2 section is carried by a TS packet with a PID of 16.

The PES format does not exist in the case of the MPEG-2 section. For that reason, the elementary stream (ES) is formed when the payloads of TS packets identified by identical PIDs within the MPEG-2 transport stream are concatenated. For example, in FIG. 8, the TS packets 803 to 805, in which the MPEG-2 section 801 is divided and transmitted, all are identified with the PID of 200. It can be said that this is an ES which transmits the MPEG-2 section S80.

A concept called a program further exists in the MPEG-2 transport stream. The program is expressed as a collection of ESs, and is used in the case where handling a plurality of ESs all together is desirable. When the program is used, it is possible to handle video/audio, as well as accompanying data broadcast data, all together. For example, in the case of simultaneously handling the video/audio to be reproduced, by grouping the video ES and the audio ES as a program, it can be seen that the broadcast recording and reproduction apparatus should simultaneously reproduce these two ESs as one TV program.

To express the program, two tables, called a Program Map Table (PMT) and a Program Association Table (PAT), are used in MPEG-2. Detailed descriptions can be found in the specifications of ISQ/IEC 13818-1, “MPEG-2 Systems”. The PMT and the PAT shall be briefly described hereafter.

The PMT is a table which includes the number of programs in the MPEG-2 transport stream. The PMT is configured as an MPEG-2 section, and has a table_id of 2. The PMT holds a program number used in identifying the program and additional information of the program, as well as information regarding an ES belonging to the program.

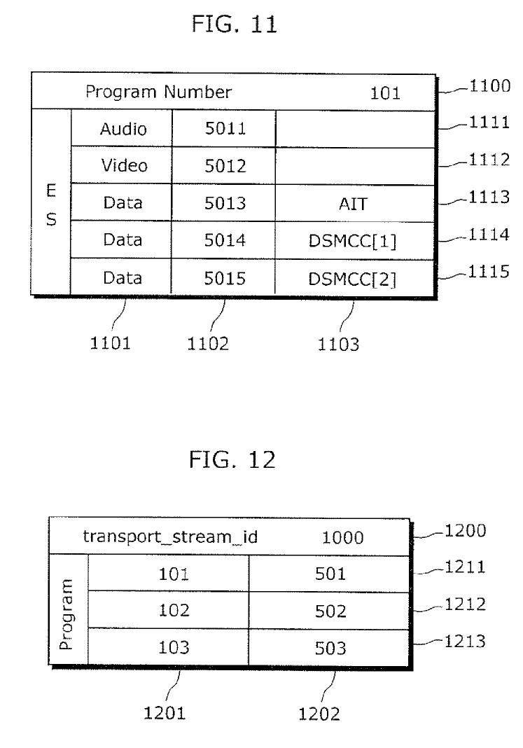

An example of the PMT is given in FIG. 11. 1100 is a program number. The program number is assigned uniquely to programs in the same transport stream, and is used in identifying the PMT. Rows 1111 to 1115 express information regarding individual ESs. Column 1101 is the type of ES, in which “video”, “audio”. “data”, and so on are specified, Column 1102 is the PID of the TS packets that make up the ES. Column 1103 is additional information regarding the ES. For example, the FS shown in row 1111 is an audio ES, and is transmitted by TS packets with a PID of 5011.

The PAT is a table, of which only one is present, in the MPEG-2 transport stream. The PAT is configured as an MPEG-2 section, has a table_id of 0, and is transmitted by a TS packet with a PID of 0. The PAT holds a transport_stream_id used in identification of the MPEG-2 transport stream, and information regarding all PMTs that represent a program existing in the MPEG-2 transport stream.

An example of the PAT is given in FIG. 12. 1200 is a transport_stream_id. The transport_stream_id is used in identifying the MPEG-2 transport stream. Rows 1211 to 1213 express information regarding the program. Column 1201 is the program number. Column 1202 is the PID of the TS packet which sends the PMT that corresponds to the program. For example, the PMT of the program shown in row 1211 has a program number of 101, and the corresponding PMT is transmitted by the TS packet with a PID of 501.

In the case where the terminal apparatus reproduces a certain program, the terminal apparatus uses the PAT and the PMT and specifies the video and audio that make up a program, and reproduces that video and audio. For example, in regards to the MPEG-2 transport stream that transmits the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”. The PAT is searched for a program with the program number “101”, and row 1211 is obtained. From row 1211, the PID “501”, of the TS packet which transmits the PMT of the program with a program number “101”, is obtained. Next, the PMT transmitted as the MPEG-2 section with a table_id of “2” is acquired from the TS packet with the PID of “501”. Row 1111, which is audio ES information, and row 1112, which is video ES information, are obtained from the PMT. A PID “5011” of the TS packet which transmits the audio ES is obtained from row 1111. In addition, a PID “5012” of the TS packet which transmits the video ES is obtained from row 1112. Next, an audio PES packet is acquired from the TS packet with a PID “5011”, and a video PES packet is acquired from the TS packet with a PID of “5012”. Through this, it is possible to acquire the video and audio ES packets to be reproduced, and the video and audio that make up the program number 101 can be reproduced.

Note that there are cases where the MPEG-2 transport stream is scrambled. This is a setup called limited viewing. For example, by scrambling the PES packets which transmit a certain video and audio, only specified viewers who can descramble the PES packets are able to view that video and audio. In order to descramble and view the video and audio, a viewer must perform descrambling using a device called a descrambler. For example, in an OCAP-compatible terminal apparatus, a card-form adapter with an internal descrambler is used, A cable television operator distributes an adapter configured to be able to decode a specified program to each viewer, and the viewer inserts that adapter into the terminal apparatus. Upon doing so, the adapter descrambles the specified program based on descrambling information such as a descrambling key and contract information of each contract holder. A method of descrambling, a method of obtaining the descrambling key, and the like depend on the adapter, and have no influence on the implementation of the present invention.

Thus far, simple descriptions regarding the MPEG-2 specifications have been given; hereafter, detailed definitions of terminology are given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the lava language is called a “Java program”.

Description has been given regarding several kinds of general information specified in the MPEG-2 specifications according to the present invention. Hereafter, the broadcast recording and reproduction terminal used in the present embodiment shall be described in detail.

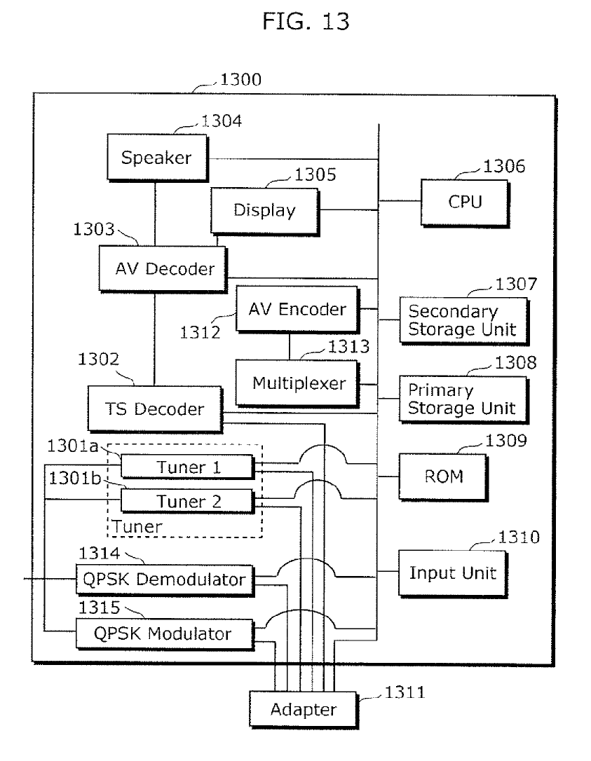

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; a QPSK demodulating unit 1314, and a QPSK modulating unit 1315. Note that the present embodiment is obtained by expanding a broadcast recording and reproduction terminal implemented by the OCAP-DVR specifications, and the specific hardware configuration is nearly identical to that required by the OCAP-DVR specifications.

The tuner 1301 is a device which demodulates a broadcast signal modulated and transmitted from the broadcast station system 101, in accordance with tuning information including a frequency prescribed by the CPU 1306. An MPEG-2 transport stream obtained as a result when the QAM demodulator 1301 of the tuner 1301 demodulates the In-band signal passes through the adapter that has a descrambling function, and is sent to the TS decoder 1302. In the present embodiment, two examples, or in other words, the tuner 1301a and the tuner 1301b are present, but both have the same function. Hereafter, the name “tuner 1301” shall be used when describing characteristics common to the two tuners.

The TS decoder 1302 is a device which has a function to segregate PES packets and MPEG-2 sections which comply with specified conditions from the MPEG-2 transport stream, based on a PID, a section filter condition, and so on prescribed by the CPU 1306. This segregation function is called packet filtering. Two types of filter devices, which are a PID filter and a section filter, are included within the TS decoder. Details on filtering shall be given later. Input of the MPEG-2 transport stream to the TS decoder is performed by plural types of constituent elements. In the case where a broadcast is received and a service is reproduced without recording, the MPEG-2 transport stream which the adapter 1311 outputs is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306, which receives an instruction from software.

The PES packets of the video and audio which the TS decoder 1302 segregated are outputted to the AV decoder 1303. In addition, the MPEG-2 section segregated by the TS decoder 1302 is transmitted to the primary storage unit 1308 through Direct Memory Access (DMA), and is used by a program and the like executed by the CPU 1306.

The AV decoder 1303 is a device with a function to decode the encoded video ES and audio ES. The AV decoder fetches the ES from the PES packet that transmits the audio and video information sent from the TS decoder, and decodes the ES. An audio signal and a video signal obtained through the decoding performed by the AV decoder 1303 are sent to the speaker 1304 and the display 1305 at the time of service reproduction, but are sent to the AV encoder 1312 at the time of service recording, Which output route to take is controlled by the CPU 1306, which receives an instruction from software.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU executes a program downloaded from a broadcast signal or a network and held in the secondary storage unit 1307. The tuner 1301, TS decoder 1302, AV decoder 1303, speaker 1304, display 1305, secondary storage unit 1307, primary storage unit 1308, ROM 1309, input unit 1310, adapter 1311, AV encoder 1312 and multiplexer 1313 are controlled in accordance with the directions of the executed program. In addition, the CPU 1306 may communicate not only with devices present within the terminal apparatus 1300, but also with the devices within the adapter 1311, and may control the adapter 1311.

The secondary storage unit 1307 is a memory apparatus, the memory of which is not deleted even if the power supply to the device is interrupted. The secondary storage unit 1307 is configured of devices, e.g., a nonvolatile memory such as a FLASH-ROM, a Hard Disk Drive (HDD), rewritable media such as a CD-Rs, DVD-Rs, and so on, the information of which is not deleted even if the power supply of the terminal apparatus 1300 is cut off. The secondary storage unit 1307 saves information according to an instruction from the CPU 1306.

The primary storage unit 1308 is a device which has a function for temporarily saving information in accordance with an instruction from the CPU 1306, a DMA-transferable device, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

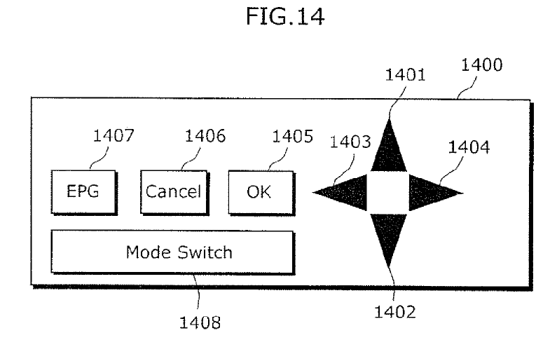

The input unit 1310 is, to be more specific, configured of a front panel or a remote control, and accepts input from the user. FIG. 14 is one example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an FPG button 1407, and a mode switch button 1408. When the user presses a button, the CPU 1306 is notified of an identifier of the pressed button.

The adapter 1311 is a device for descrambling the MPEG-2 transport stream sent in the In-band frequency range, and includes one or more descramblers. The NPEG-2 transport stream outputted by the tuner 1301a is inputted into the adapter 1311, and the TS packet that has the PIE specified by the CPU 1306 is descrambled. The adapter 1311 outputs the descrambled MPEG-2 transport stream to the TS decoder 1302.

Furthermore, the adapter 1311 carries out format conversion of data sent in an OOB frequency range. Information that is sent OOB is modulated in the QPSK modulation format. Regarding outbound transmission, the QPSK demodulator 1314 demodulates so the outbound signal sent from the broadcast station system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding incoming transmission, the CPU 1306 inputs information to be sent to the broadcast station system 101 into the adapter 1311. The adapter 1311 converts the information inputted from the CPU 1306 to a format that can be interpreted by the broadcast station system 101, and inputs this to the QPSK modulator 1315. The QPSK modulator 1315 QPSK-modulates the information inputted from the adapter 1311, and sends this to the broadcast station system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313. The AV encoder 1312 can be implemented through publicly-known technology.

The multiplexer 1313 is a device which has a function to multiplex, into an MPEG-2 transport stream, video and audio inputted from the AV encoder 1312 as well as private section data filtered and separated by the TS decoder. The multiplexer 1313 can be implemented though publicly-known technology.

A process in which the broadcast recording and reproduction apparatus described above records a service contained in a broadcast signal into the secondary storage unit 1307, and a process where the broadcast recording and reproduction apparatus consecutively reads out and reproduces the service from the secondary storage unit 1307, are hereafter described in detail.

First, the process in which the service contained in the broadcast signal is recorded into the secondary storage unit 1307 is described.

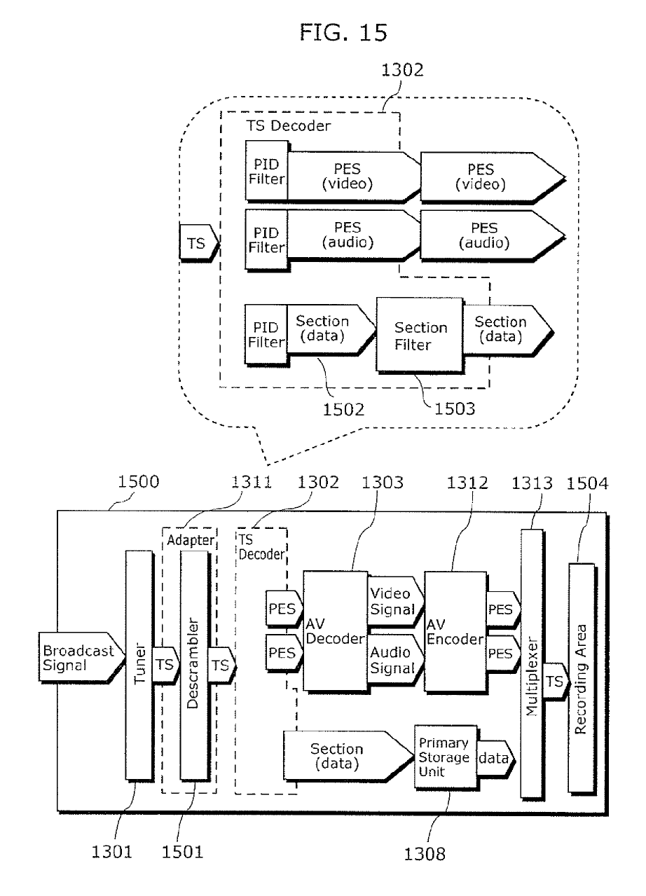

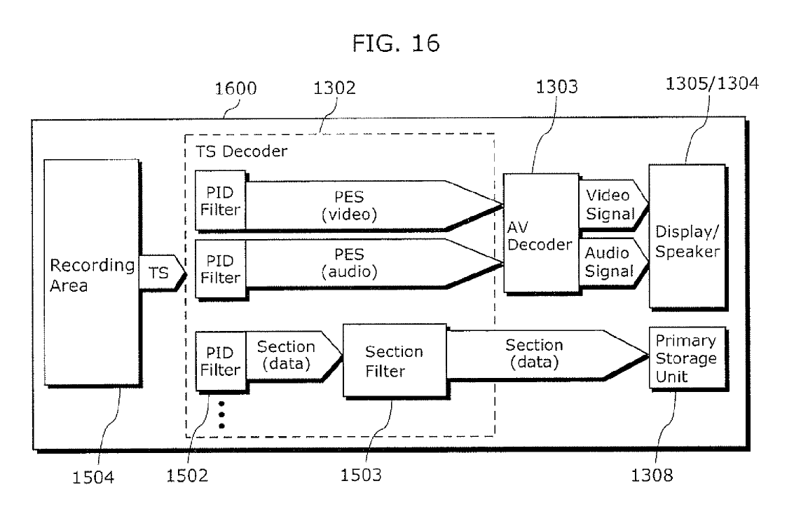

FIG. 15 shows a conceptual rendering which expresses the physical connection sequence, processing details, and input/output data format of each device during recording of the service. 1500 is a terminal apparatus, which has: the tuner 1301; the adapter 1311; a descrambler 1501; the TS decoder 1302; a PIP filter 1502; a section filter 1503; the AV decoder 1303; the primary storage unit 1308; the AV encoder 1312; the multiplexer 1313; and a recording area 1504. Constituent elements in FIG. 15 that have the same numbers as in FIG. 13 have the same functions and thus descriptions shall be omitted.

First, the tuner 1301 performs tuning on the broadcast wave in accordance with a tuning instruction provided by the CPU 1306. The tuner 1301 demodulates the broadcast signal and inputs the MPEG-2 transport stream into the adapter 1311.

The descrambler 1501, which is within the adapter 1311, descrarmbles the MPEG-2 transport stream based on limitation removal information for each viewer. The descrambled MPEG-2 transport stream is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, a TS packet that has a PID specified by the CPU 1306, and then extracts a PES packet and anr MPEG-2 section present in that payload. For example, when the MPEG-2 transport stream in FIG. 6 is inputted in the case where the CPU 1306 has instructed PID filtering, which extracts the TS packet with a PID of 100, packets 601 and 603 are extracted, then concatenated, and thereby a PES packet of the video 1 is reconstructed. Or, when the MPEG-2 transport stream in FIG. 6 is inputted in the case where the CPU 1306 has instructed PID filtering, which extracts the TS packet with a PID of 200, packets 602 and 605 are extracted, then concatenated, and thus an MPEG-2 section the data 1 is reconfigured.

The section filter 1503 extracts the MPEG-2 section which conforms to a section filter condition specified by the CPU 1306 from among the inputted NPEG-2 sections, and DMA-transfers this MPEG-2 section to the primary storage unit 1308. A PID value can be specified as the section filter condition, and a table_id value can be specified as an auxiliary condition. For example, the CPU 1306 specifies PID filtering which extracts the TS packet with a PID of 200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308, which is a buffer.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet and converts the video, and inputs this into the AV encoder 1312. The AV decoder also decodes the audio PES packet and converts the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder onto the MPEG-2 section inputted from the primary storage unit 1308, and thus generates an MPEG-2 transport stream. The generated MPEG-2 transport stream is recorded into the recording area 1504. Note that there are cases where the multiplexer 1313 has a descrambling function.

The recording area 1504 is made up of all or a part of the secondary storage unit 1307, or an other recording area, and records the MPEG-2 transport stream that makes up a service.

Next, a process in which the service is consecutively read out from the secondary storage unit 1307 and reproduced shall be described.

FIG. 16 shows a conceptual rendering which expresses the physical connection sequence, processing details, and input/output data format of each device during reproduction of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same numbers as in FIG. 13 have the same functions and thus descriptions shall be omitted.

The MPEG-2 transport stream recorded in the recording area 1504 in the procedure illustrated in FIG. 15 is inputted into the TS decoder 1302.

Then, a video PES and an audio PES that have a PID specified by the CPU 1306 are extracted by the PID filter 1502 within the TS decoder 1302. The extracted PES packet is inputted into the AV decoder 1303. Or, the MPEG-2 section that has a PID and a table_id specified by the CPU 1306 is extracted by the PID filter 1502 and the section filter 1503 within the TS decoder 1302. The extracted MPEG-2 section is DMAtransferred to the primary storage unit 1308.

The video PES and the audio PES inputted into the AV decoder 1303 are decoded, and outputted as an audio signal and a video signal. After that, the audio signal and the video signal are inputted into the display 1305 and the speaker 1304, and thus the audio and the video are reproduced.

The MPEG-2 section inputted into the primary storage unit 1308 is inputted into the CPU 1306 and used by software when appropriate,

Note that in the case where the recorded content has been scrambled, it is necessary to perform descrambling processing in the above-mentioned processing. In such a case, it is necessary to use a descrambling device to perform the descrambling, but as this can be implemented through publicly-known technology, and has no direct relationship with the present invention, descriptions thereof shall be omitted.

Thus far, an example of a hardware configuration regarding the present invention has been described. Hereafter, a chief function of the present invention, which is control of recording and reproduction of the service via a Java program, is described. Services can be classified into “broadcasted services” and “recorded services”. “Broadcasted services” refers to services contained within received broadcast signals, and are services that are reproduced in real time while the broadcast is being received On the other hand, “recorded services” refers to services recorded into the secondary storage unit 1307, the reproduction of which may be commenced at any time.

Recording of the service in the present invention refers to recording video, audio, a Java program, synchronization information of the Java program, and so on that are contained in the service, into an arbitrary storage medium such as a hard disk, a Blu-ray Disc (BD), a Digital Versatile Disc (DVD), and a Secure Digital (SD) memory card. These storage media are, in the configuration diagram shown in FIG. 13, denoted as the secondary storage unit 1307. Reproduction of the recorded service refers to execution and reproduction of the video, audio, and Java program recorded in the recording medium based on the synchronization information of the Java program.

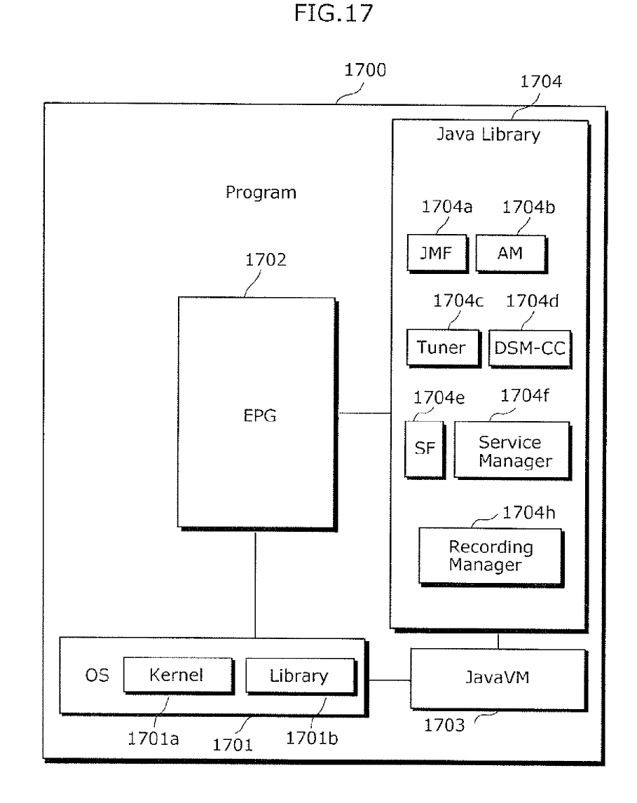

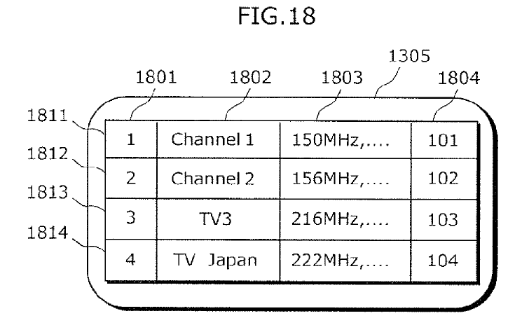

FIG. 17 is a configuration diagram of a program according to the present invention, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a for executing other sub-programs such as the EPG 1702 and the Java VM 1703; and a library 1701b which the sub-programs use to control the constituent elements of the terminal apparatus 1300. The kernel 1701a is publicly-known technology and therefore detailed descriptions shall be omitted.

The library 1701b provides, for example, a tuning function for controlling the tuner. The library 1701b accepts, from another sub-program, tuning information that includes a frequency, and supplies this to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

Also, the library 1701b provides channel information for uniquely identifying a channel. An example of the channel information is shown in FIG. 18. The channel information is sent using an OOB or an In-band frequency range, is converted into a chart format by the adapter 1311, and is stored in a temporary memory unit accessible by the library. Column 1801 is a channel identifier, and is equivalent to, for example, a source_ID as defined by SCTE65 Service Information Delivered Out-Of-Band For Digital Cable Television. Column 1802 is a channel name, and is equivalent to a source_name in the same SCTE65 standard. A column 1803 is tuning information, and is information such as a frequency, a transfer rate, a modulation formation, and the like that is given to the tuner 1301. Column 1804 is a program number for specifying the PMT. For example, row 1811 is a group of service information including a channel identifier of “1”, a channel name of “channel 1”, a frequency of “150 MHz . . . ” in the tuning information, and a program number of “101”.

In addition to this, it is also possible for the library 1701b to set parameters used in control of the hardware constituent elements shown in FIG. 13. Individual functions are described later.

The JavaVM 1703 is a Java virtual machine that sequentially analyzes and executes programs written in the Java™ language. Programs written in the Java language are compiled into intermediate code known as bytecode which do not depend on hardware. The Java virtual machine is an interpreter that executes such bytecode The Java VM 1703 executes the Java library 1704 that is written in the Java language. Details of the Java language are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are situations where a sub-program not written in the Java language, such as the library 1701b of the OS 1701, is used as necessary. The Java program can use a function provided by the Java library 1740 by calling a Java Application Programming Interface (API) held by the Java library 1704.

A tuner 1704c is a Java library for controlling the In-band receiving tuner 1301 in the broadcast recording and reproduction terminal. When the lava program passes tuning information including a frequency to the tuner 1704c, the tuner 1704 uses that information to invoke a tuning function of the library 1701b, and as a result, it is possible to control an operation of the In-band receiving tuner 1301 of the broadcast recording and reproduction terminal.

An SF 1704e is a lava library for controlling a function of the PID filter 1502 and the section filter 1503 of the broadcast recording and reproduction terminal. When the Java program passes filtering conditions such as a PID, table_id, and the like to the SF 1704e, the SF 1704e uses a function of the library 1701b based on those conditions, sets the filtering conditions in and controls the PID filter 1502 and the section filter 1503, acquires an MPEG-2 section that fulfills desirable filter conditions, and passes the MPEG-2 section to the Java program that set the filter conditions.

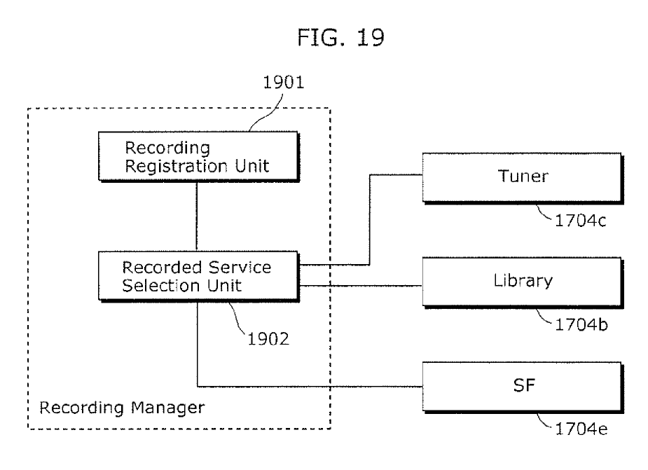

The recording manager 1704h records the MPEG-2 transport stream that includes the specified service into a normal recording area in the secondary storage unit 1307. FIG. 19 shows an internal configuration of the recording manager 1704h. The recording manager 1704h includes a record registration unit 1901 and a recorded service selection unit 1902.

With the channel identifier, start time, and end time inputted, the record registration unit 1901 records, into a normal recording area in the secondary storage unit 1307, only the space between the start time and the end time of the specified service. The record registration unit 1901 is a lava API for record registration, which has record(intsource_id, Timestart, Timeend). source_id specifies the channel identifier, start specifies the start time of recording, and end specifies the ending time of recording. In addition, the record registration unit 1901 also accepts a record registration request from non-lava programs. For example, it is possible to specify the channel identifier, start time, and end time from the EPG 1702.

When recording is registered, the recording registration unit 1901 stands by until the record start time. After that, upon arriving at the start time, the EPG 1702 supplies the specified channel identifier, record start time, and record end time to the recorded service selection unit 1902, and requests recording of the service. The recorded service selection unit 1902 records the service into the secondary storage unit based on the specified channel identifier, record start time, and record end time.

First, the recorded service selection unit 1902 secures, within the secondary storage unit 1307, a recording area 1504 for recording the MPEG-2 transport stream from the specified start time to the specified end time. A media identifier is supplied to the secured recording area. Next, with the channel identifier as a key, the recorded service selection unit 2404 obtains tuning information that corresponds to the channel identifier from channel information held by the library 1701b. After that, when the recorded service selection unit 2404 supplies the tuning information to the Tuner 1704c, the Tuner 1704c commences tuning. Here, the tuning information is information that can specify a frequency, a modulation type, and the like. In addition, as shown in FIG. 15, an input and output of the hardware constituent elements are set so that the MPEG-2 transport stream is inputted into the TS decoder via the adapter 1311.

Next, using the SF 1704e, the recorded service selection unit 1902 acquires the PAT from the MPEG-2 transport stream obtained through the tuning. After this, the library 1701b is searched to find out the program number corresponding to the specified channel identifier, and the PID of the PMT that matches that program number is acquired from the PAT. By specifying the acquired program number and PID to the SF 1704e, the PMT within the MPEG-2 transport stream is acquired, and the information denoted therein is stored in the secured recording area. Note that in the MPEG standard, the version of the PAT and the PMT may be upgraded. Therefore, the recorded service selection unit 1902 constantly filters and monitors the PATs; when the version of a PAT has upgraded, the above process is repeated, and the PMT of the service to be recorded within the MPEG-2 transport stream are obtained.

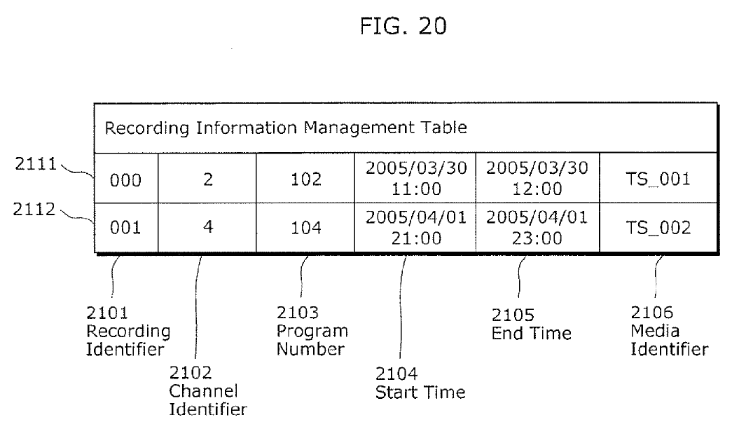

After that, when the specified end time is reached, the recorded service selection unit 2104 stops the tuning process of the Tuner 1704c, and causes the writing of the MPEG-2 transport stream to the recording area 1504 to end. In addition, a recording information management table as shown in FIG. 20 is created as management information of the MPEG-2 transport stream recorded earlier.

FIG. 20 is an example of the recording information management table for managing the recording information recorded into the recording area 1504 of the secondary storage unit 1307 and the like. The recording information is recorded in chart format. Column 2001 is a recording identifier. Column 2002 is the channel identifier specified to be recorded, Column 2003 is a corresponding program number. Column 2004 is the record start time for the service, and column 2005 is the record end time for the service. Column 2006 is a media identifier that identifies the MPEG-2 transport stream that is recorded as the service. Each of rows 2011 to 2012 is a group of each recording identifier, channel identifier, program number, start time, end time, and media identifier. For example, row 2011 shows a recording identifier of “000”, a channel identifier of “2”, a program number of “102”, a start time of “2005/03/30 11:00”, an end time of “2005/03/30 12:00”; and a media identifier of “TS_{—}001”.

A DSMI-CC 1704d is a lava library for accessing a DSM-CC object carousel filesystem. The DSM-CC object carousel is included in the MPEG-2 section acquired by the SF 1704e. The DSM-CC is defined by the ISO/IEC 13818-6 standard, and is a mechanism for using the MPEG-2 section to send an arbitrary file. By using this, it is possible to send a file from a broadcast station to a terminal. Based on a DSM-CC identifier and a file identifier specified by the Java program and so on, the DSM-CC 1704d uses the SF 1704e and acquires the MPEG-2 section, fetches a file based on the ISO/IEC 13818-6 standard, and outputs this file to the primary storage unit 1308, the secondary storage unit 1307, and the like. A detailed method for implementing the DSM-CC is of no relation to the present invention, and therefore details shall be omitted.

An AM 1704b is an Application Manager that provides a function for managing the execution and termination of the Java programs contained in the service. The AM 1704b extracts a Java program multiplexed into a channel specified by a specified NPEG-2 transport stream, and causes the execution or termination of that extracted Java program in accordance with separately-multiplexed synchronization information. A Java class file of the Java program is multiplexed onto the MPEG-2 transport stream based on the aforementioned DSM-CC method. In addition, the synchronization information of the Java program is in a format called AIT, and is multiplexed into the MPEG-2 transport stream. AIT is an acronym of “Application Information Table”, and is an MPEG-2 section with a table_id of “0x74”.

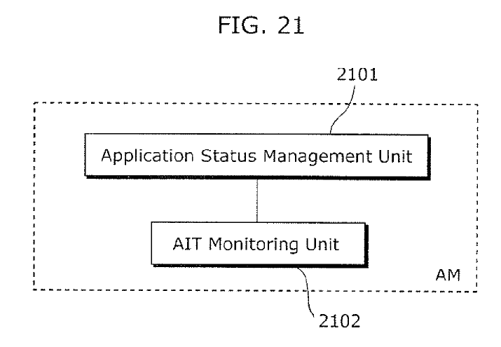

An internal configuration of the AM 1704b is shown in FIG. 21. The AM 1704b is configured of an AIT monitoring unit 2102 and an application status management unit 2101.

The AIT monitoring unit 2102 monitors an update state of the AIT, with the private section and the channel identifier of the MPEG-2 transport stream that is outputted from the TS decoder at the time of service reproduction as an input. First, the AIT monitoring unit 2102 searches channel information in the library 1701b with a specified channel identifier as a key, and obtains the program number of the corresponding service. In the case where the recording identifier has been specified, the recording manager 1704h searches the recording information management table it manages using the specified recording identifier as a key, and obtains the program number. Next, using the SF 1704e and the like, a PAT is acquired from the MPEG-2 transport stream. Then, the PID of a PMT that corresponds to the obtained program number is obtained from information of the PAT. Once again, using the SF 1704e, the actual PMT is acquired. The acquired PMT is in a format as shown in FIG. 11, and has written the PID of an elementary stream that has “data” as a stream identifier and “AIT” as supplemental information. Furthermore, when the PID and table_ID “0x74” of the AIT now obtained as the filtering conditions are given to the SF 1701e, the actual AIT is obtained.

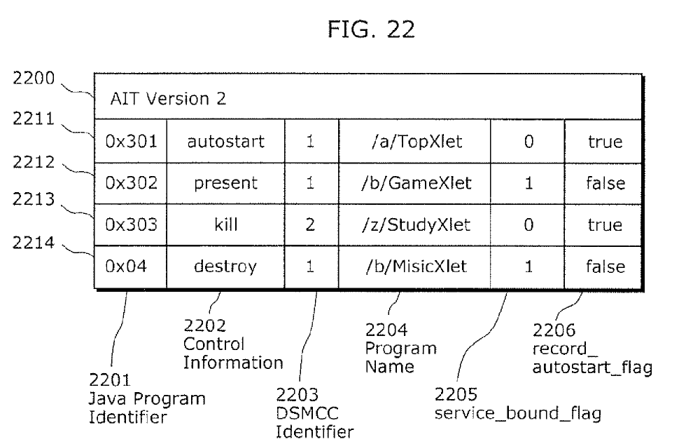

FIG. 22 is a chart that schematically shows an example of the AIT. An AIT version number 2200 expresses the version of that AIT. The higher the version of the AIT, the newer the ATT is. ATT of the same AIT version are repeatedly received, but the AIT monitoring unit 2102 ignores and does not acquire AIT with the same AIT version as an AIT that has already been acquired, only acquiring an AIT that is newer than the already-acquired AITl The AIT monitoring unit 2102 outputs a newly-acquired AIT to the application status management unit 2101 each time an AIT is newly acquired. Column 2201 is an identifier of the Java program.

According to the MHP standard, this identifier is defined as an Application ID. Column 2202 is control information of the Java program. In the control information, there is “autostart”, “present”, “destroy”, “kill”, and the like; “autostart” means that the terminal apparatus 1300 starts the Java program automatically and instantly, and “present” means not performing automatic starting. Java programs for which “present” is specified are started when instructed to start by another Java program. This instruction method is of no relation to the present invention, and thus descriptions shall be omitted. “Destroy” and “kill” mean that the Java program is to be terminated. Column 2203 is a DSN-CC identifier for extracting the PID that includes the Java program, based on the DS-MCC method. Column 2204 is a program name of the Java program. Column 2205 is a service_bound_flag, where 1 means that the Java program will undoubtedly end when a different service is selected. 0 means that when another service is selected, in the case where the Java program that also corresponds to the AIT of that service is denoted, that Java program continues to be executed without being terminated. However, even in the case of 0, the control information of a Java program in a newly-selected service is given priority. Column 2206 is a record-autostart-flag. This flag is referred to when reproducing a recorded service. “true” indicates that the Java program indicated in the aforementioned column 2202 is to be started automatically when the recorded service is reproduced regardless of that Java program's control information. “false” indicates that the Java program indicated in column 2202 shall act in accordance with the control information. Rows 2211, 2212, 2213, and 2214 are groups of the information of the Java program. As an example, the Java program defined by row 2211 is a combination of the Java program identifier “0x3001”, the control information “autostart”, the DSIM-CC identifier “1”, the program name “a/TopXlet”, a service_bound-flag of “0”, and a record_autostart_flag of “true”. In the same manner, the Java program defined in row 2212 is a group including a Java program identifier of “0x3002”, the control information “present”, a DSM-CC identifier of “1”, a program name of “b/GameXlet”, a service_bound_flag of “1”, and a record_autostart_flag of “false”, Here, the three Java programs defined by rows 2211, 2212, and 2214 have the same DSM-CC identifier. This indicates that three Java programs are included in one file system encoded in the DSM-CC format. In the AIT, there are actually many more types of information aside from those prescribed here; however, such information is of no relation to the present invention and thus descriptions shall be omitted.

Note that the record_autostart_flag in column 2206 may be denoted in any form within the AIT; for example, it may be held as an AIT field In addition, descriptors, which add additional information, can be inserted within the AIT per Java program, and thus a record autostart descriptor is defined; the record_autostart_flag can be considered to be “true” in the case where the record autostart descriptor is present in the “area in which the descriptor is inserted per Java program” within the AIT and “false” in the case where the record autostart descriptor is not present. Furthermore, the record autostart descriptor may include the record_autostart_flag.

The application status management unit 2101 analyzes a content of the renewed AIT outputted from the AfT monitoring unit 2102, and manages an execution status of the Java program based on that content of the AIT. How the operation performed by the application status management unit 2101 selects the Java program to be started automatically differs depending on whether a “broadcast service” or a “recorded service” is to be reproduced.

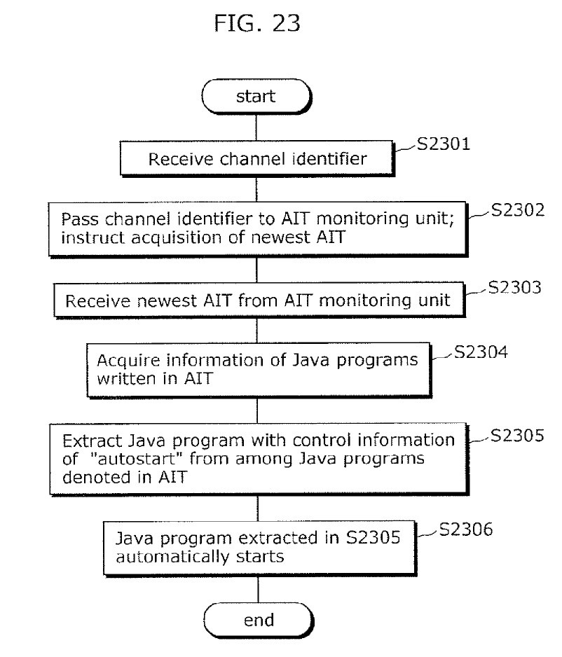

First, a method for determining the Java program to be started automatically when a “broadcast service” is reproduced shall be described. FIG. 23 shows an operational sequence of the application status management unit 2101 when a broadcast service is reproduced. Upon being passed the channel identifier and being instructed to start the Java program included within the broadcast service (S2301), the application status management unit 2101 first provides the ATT monitoring unit 2102 with an instruction to start monitoring the AIT (S2302). When the newest AIT is received from the AIT monitoring unit 2102 (S2303), the AIT is analyzed and the Java program information acquired (52304), the control information held in column 2202 is examined and the Java program with control information of “autostart” is extracted (S2305). The Java program extracted in S2305 is considered to be a Java program to be started automatically when the “broadcast service” is reproduced, and is started through a process described later (S2306).

Next, a method for determining the Java program to be started automatically when a “recorded service” is reproduced shall be described.

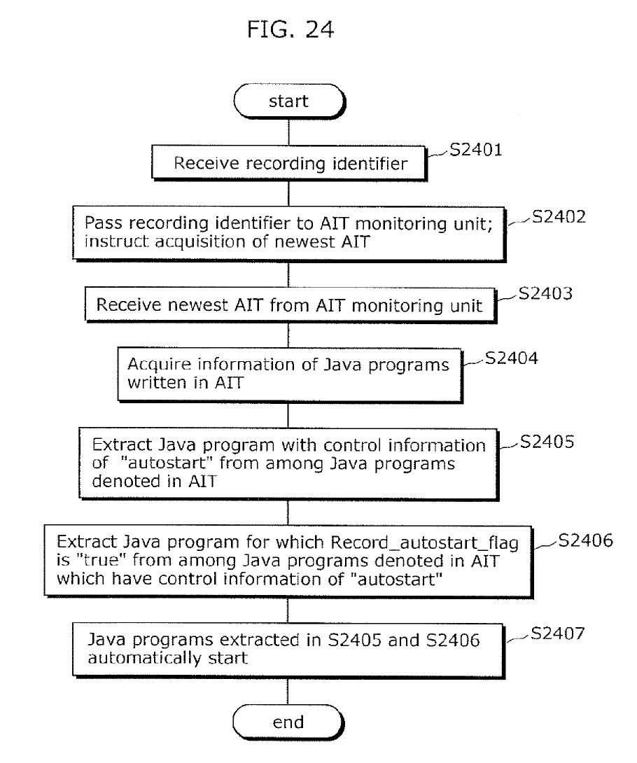

FIG. 24 shows an operational sequence of the application status management unit 2101 when a recorded service is reproduced. Upon being passed the recording identifier and being instructed to start the Java program included within the recorded service (S2401), the application status management unit 2101 first provides the AIT monitoring unit 2102 with an instruction to start monitoring the AIT (52402). When the newest AIT is received from the AIT monitoring unit 2102 (S2403), the AIT is analyzed and the Java program information acquired (S2404), the control information held in column 2202 is examined and the Java program with control information of “autostart” is extracted (52405). The Java programs extracted in S2405 and S406 are considered to be Java programs to be started automatically when the “recorded service” is reproduced, and is started through a process described later (52307). Such a Java program is aiso treated as a Java program to be started automatically. The Java programs extracted in S2405 and 5406 are considered to be Java programs to be started automatically when the “recorded service” is reproduced, and are started through a process described later (S2407).

The Java program to be started automatically is determined through the above algorithm. In the case where more than one Java program matches the above criteria at the same time, all Java programs that match are started automatically.

When the Java programs to be started automatically are determined, the corresponding DSM-CC identifiers and Java program names are extracted. Referring to FIG. 22, the AM 1704b extracts the Java program frcrn row 2211 and acquires the DSM-CC identifier of “1” and the Java program name of “a/TopXlet”. Next, the application status management unit 2101 uses the DSM-CC identifier acquired from the AIT to access the DSM-CC 1704d, and can fetch a Java program file in a DSM-CC file system. The File is stored in the primary storage unit 1308, the secondary storage unit 1307, and so on. Fetching data such as the file system from the TS packet of the MPEG-2 transport stream and saving the data into a storage means such as the primary storage unit 1308 and the secondary storage unit 1307 is hereafter called downloading.

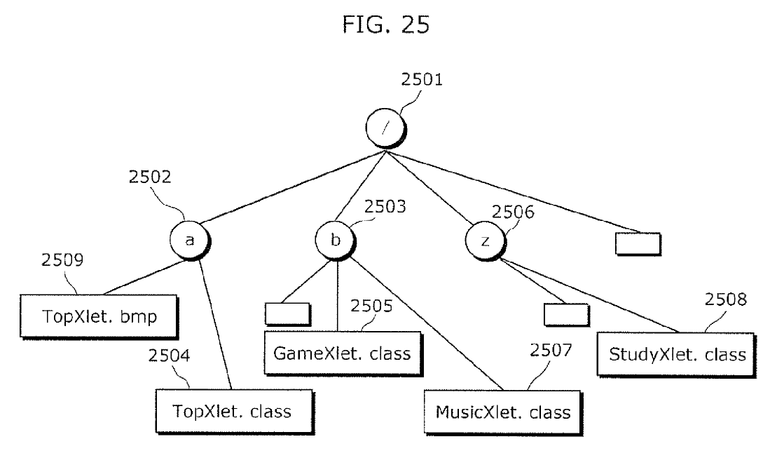

FIG. 25 is an example of a downloaded file system. In the diagram, a circle represents a directory and a square represents a file. 2501 is a root directory, 2502 is a directory “a”, 2503 is a directory “b”, 2504 is a file “TopXlet.classt”, 2505 is a file “GameXlet.class”, 2506 is a directory “Z”, 2507 is a file “MusicXlet.class”, and 2508 is a file “StudyXlet.class”.

Next, the application status management unit 2101 passes the Java program to be executed to the Java VM 1703, from among the file systems downloaded to the primary storage unit 1308. Here, when the name of the Java program to be executed is “A/TopXlet” the file “a/TopXlet.class”, in which “.class” is added to the end of the Java program name, is the file to be executed, “/” is a directory and file name division, and referring to FIG. 25, the file 2504 is the Java program which should be executed. The file is executed in the Java VM as the Java program.

The application status management unit 2101 analyzes the AIT each time an AIT with a new AIT version is outputted from the AIT monitoring unit 2102 and changes an execution status of the Java program.

A JMF 1704a handles control of reproduction of the video and audio contained in the service. Specifically, at the time of reproduction of the service, the JMF1704a causes a specific video ES and audio ES from the MPEG-2 transport stream outputted from the TS decoder to be inputted into the AV decoder.

The channel identifier of a channel to be reproduced is inputted into the JMF 1704a. First, the JMF 1704a searches channel information in the library 1701b with a specified channel identifier as a key, and obtains the program number. Next, using the SF 1704e and the like, a PAT is acquired from the MPFG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PIDs of elementary streams that have “video” and “audio” as the stream identifiers. When the JMF 1704a sets those PIDs in the PID filter 1502 of the TS decoder 1302 via the library 1701b, the video ES and the audio ES, onto which those PIDs are multiplexed, are decoded by the AV decoder 1303, as shown in FIG. 16. The decoded audio and video are reproduced through the speaker 1304 and the display 1305.

A service manager 1704f manages reproduction of the service within the MPEG-2 transport stream that has been recorded into the secondary storage unit 1307, or the service within the MPEG-2 transport stream inputted from the adapter 1311.

First, a process in the case of managing reproduction of the service contained within the MPEG-2 transport stream recorded in the secondary storage unit 1307 shall be described hereafter. This is equivalent to reproduction of a recorded service. In this case, the service manager 1704f is inputted with the recording identifier. Only the service already recorded in the secondary storage unit 1307 and specified by that recording identifier is to be reproduced, First, referring to the recording information management table created by the recording manager 1704h, the service manager 1704f obtains the channel identifier of the channel to be reproduced, through the specified recording identifier.

Then, through the library 1701b, the service manager 1704f instructs the secondary storage unit 1307 to output, to the TS decoder 1302, the MPEG-2 transport stream specified by the obtained media identifier. In addition, through the library 1701b, the service manager 1704f sets the output destination of each hardware constituent element to flow through the path shown in FIG. 16. After that, the secondary storage unit 1307 is provided to the JMF 1704a as the location of the MPEG-2 transport stream, and the channel identifier to be reproduced is provided. Then, through the process described above, the IMF 1704a starts reproduction of the audio and video multiplexed into the MPEG-2 transport stream outputted from the secondary storage unit 1307,

Furthermore, the recording identifier of the channel to be reproduced is provided to the application status management unit 2101 of the AM 1704b. Then, in accordance with the AIT multiplexed into the MPEG-2 transport stream outputted from the secondary storage unit 1307 via the TS decoder 1302, the AM 1704b commences execution and termination of the Java program multiplexed into the same MPEG-2 transport stream, in the manner described earlier. After that, reproduction of the service is continued until the end of the MPEG-2 transport stream outputted from the secondary storage unit 1307.

Next, managing reproduction of the service within the MPEG-2 transport stream inputted from the adapter 1311 shall be described. This is equivalent to reproduction of a broadcast service. In this case, the channel identifier is inputted into the service manager 1704f. The currently-broadcasted service specified by that channel identifier is the service to be reproduced. First, with the channel identifier as a key, the service manager 1704f obtains tuning information that corresponds to the channel identifier from channel information held by the library 1701b. Then, the tuning information is passed to the Tuner 1704c, which is instructed to perform tuning. The Tuner 1704c controls the tuner 1301, thereby performing tuning. The MPEG-2 transport stream selected through the tuning process passes through the adapter 1311 and on to the TS decoder 1302.

After that, the channel identifier of the channel to be reproduced is passed to the IMF. Then, through the process described above, the IFN 1704a starts reproduction of the audio and video multiplexed within the MPEG-2 transport stream outputted from the tuner 1301. Furthermore, the channel identifier to be reproduced is provided to the AIT monitoring unit 2102 of the AM 1704b. Then, in accordance with the AIT multiplexed into the MPEG-2 transport stream outputted from the tuner 1301 via the TS decoder, the AM 1704b commences execution and termination of the lava program multiplexed into the same MPEG-2 transport stream.

The EPG 1702 is an Electric Program Guide, and is a function which lets a user choose a TV program to be recorded and reproduced. Reproduction of the broadcast service is carried out by the channel identifier being passed to the service manager 1704f.

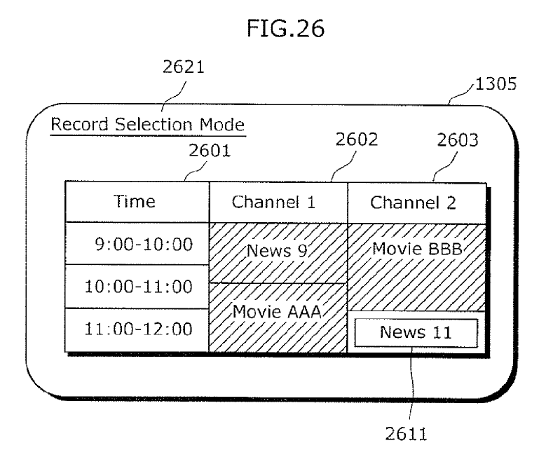

In the case of reproducing the TV program, the EPG 1702 displays a list of broadcasted TV programs, and lets the user choose a desired TV program. FIG. 26 is an example of a screen display for allowing the user select a TV program to be recorded. A time 2601 and channels 2602 and 2603 are displayed in a grid, and it is possible to check the TV programs of each recordable channel at each time. It is possible for the user to move a focus 2611 around the screen by using up, down, right, and left cursor buttons 1401 to 1404, which are included in the input unit 1310 of the terminal apparatus 1300. Furthermore, when the OK button 1405 is pushed, the TV program which the focus currently highlights is selected to be reproduced. The EPG 1702 acquires the channel identifier of the TV show from the library, and when the TV show to be recorded is selected by the user, passes the channel identifier of that TV show to the service manager 1704f.

In the case of recording the TV program, the EPG 1702 displays a list of broadcasted TV programs, and lets the user choose a desired TV program. FIG. 26 is an example of a screen display for allowing the user select a TV program to be recorded. A time 2601 and channels 2602 and 2603 are displayed in a grid, and it is possible to check the TV programs of each recordable channel at each time. It is possible for the user to move a focus 2611 around the screen by using up, down, right, and left cursor buttons 1401 to 1404, which are included in the input unit 1310 of the terminal apparatus 1300. Furthermore, when an OK button 140$ is pushed, the TV program which the focus currently highlights is selected to be recorded. The EPG 1702 acquires the channel identifier of the TV show from the library, and when the TV show to be recorded is selected by the user, notifies the channel identifier, start time, and end time of the TV show to the record registration unit 1901 of the recording manager 1704h.

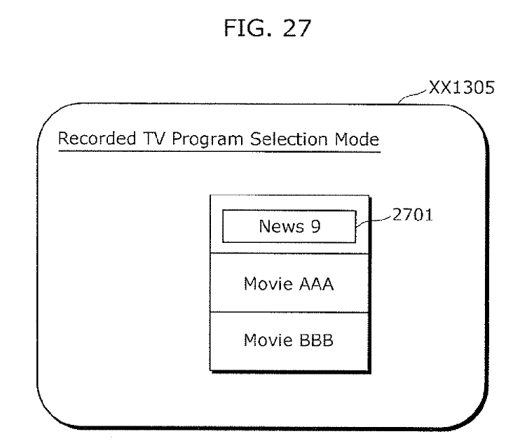

On the other hand, in the case of reproducing an already-recorded TV program, the EPG 1702 displays a list of the already-recorded TV programs, and lets the user choose a desired TV program. FIG. 27 is an example of a screen display for allowing selection of a recorded TV program. All TV programs stored in the secondary storage unit 1307 at that point in time are listed. It is possible for the user to move a focus 2701 around the screen by using the up and down cursor buttons 1401 and 1402, which are included in the input unit 1310 of the terminal apparatus 1300. Furthermore, when the OK button 1405 is pushed, the TV program which the focus currently hits is selected to be reproduced. The EPG 1702 acquires the recording identifier of the TV program from recording manager 1704h, and when the TV program to be reproduced is selected by the user, notifies the service manager 1704f of the recording identifier of that TV program. Based on that information, the service manager 1704f reads out and reproduces the TV program from the secondary storage unit 1307.

With the method according to the present embodiment, the AM 1704b changes the method of selecting the lava program to start automatically depending on whether a broadcast service or a recorded service is specified; alternatively, the lava program to be automatically reproduced is changed.

Regarding lava programs for which startup is to be prohibited when reproducing a broadcast service but for which automatic startup is to be performed when reproducing a recorded service, such a setup can be implemented through the broadcast station system specifying, at the time of sending, “kill” in the control information in column 2202 and “true” in the record_autostart_flag in column 2206 of the AIT.

In addition, regarding Java programs for which automatic startup is not to be performed when reproducing a broadcast service but for which automatic startup is to be performed when reproducing a recorded service, such a setup can be implemented through the broadcast station system specifying, at the time of sending, “present” in the control information in column 2202 and “true” in the record_autostart_flag in column 2206 of the AIT.

Finally, regarding Java programs which are to be started in both cases, such a setup can be implemented through the broadcast station system specifying, at the time of sending, “autostart” in the control information in column 2202 of the AIT.

### Second Embodiment

In the first embodiment, the record_autostart_flag is introduced in the AIT, and it is possible to change the Java program to be started automatically depending on whether a service being reproduced is a broadcast service or a recorded service. However, with the method of the first embodiment, it is not possible to implement a system in which, for example, a certain Java program is to be started automatically when reproducing a broadcast service, but is not to be started automatically when reproducing a recorded service, and rather another Java program is to be started at that time. The present invention provides a more highly flexible method of specifying Java programs.

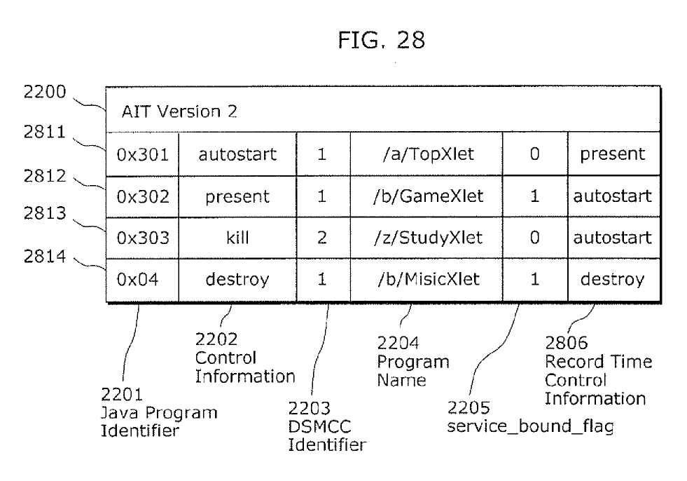

Hereafter, the AIT of the present embodiment is shown in FIG. 28. Items indicated by the same numbers as in FIG. 22 have already been described with reference to FIG. 22, and thus further descriptions shall be omitted. Column 2806 is record time control information. As opposed to column 2202, which shows the control information at the time of reproducing a broadcast service, the record time control information in column 2806 is assumed to refer to the time of reproducing a recorded service. Rows 2811, 2812, 2813, and 2814 are groups of the information of the Java program. As an example, the Java program defined by row 2811 is a combination of the Java program identifier “0x3001”, the control information “autostart”, the DSM-CC identifier “1”, the program name “a/TopXlet”; a service_bound_flag of “0”, and record time control information of “present”. In the same manner, the Java program defined in row 2812 is a group including a Java program identifier of “0x3002”, the control information “present”, a DSM-CC identifier of “1”,“a program name of “b/GameXlet”, a service_bound_flag of “1”, and record time control information of “autostart”.

Note that the record time control information in column 2806 may be denoted in any form within the AIT; for example, it may be held as an AIT field. In addition, descriptors, which add additional information, can be inserted within the AIT per Java program, and thus a record time control information descriptor is defined; the record time control information which the record time control information descriptor holds can be treated as the record time control information of the Java program in question in the case where the record autostart descriptor is present in the “area in which the descriptor is inserted per Java program” within the AIT.

Hereafter, a method through which the application status management unit 2101 determines the Java program that is to start automatically when starting a service.

The time of reproducing a service is the same as that described in the first embodiment.

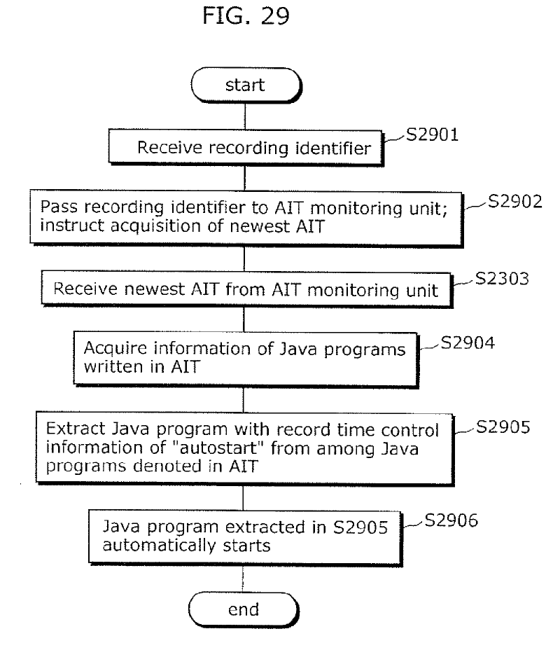

A method for determining the Java program to be started automatically when a recorded service is reproduced shall be described. FIG. 29 shows an operational sequence of the application status management unit 2101 when a recorded service is reproduced. Upon being passed the recording identifier and being instructed to start the Java program included within the recorded service (S2901), the application status management unit 2101 first provides the AIT monitoring unit 2102 with an instruction to start monitoring the ATT (52902). When the newest AIT is received from the AIT monitoring unit 2102 (S2903), the AIT is analyzed and the Java program information acquired (S2904), the record time control information held in column 2202 is examined and the lava program with record time control information of “autostart” is extracted (S2905). The Java program extracted in S2905 is considered to be a Java program to be started automatically when the recorded service is reproduced, and is started through the process described in the first embodiment (S2906).

With the method according to the present embodiment, the AM 1704b changes the method of selecting the Java program to start automatically depending on whether a broadcast service or a recorded service is specified; alternatively, the Java program to be automatically reproduced is changed. Particularly in the present embodiment, it is possible to write completely separate application control information depending on whether a broadcast service or a recorded service is being reproduced; therefore, it is possible to write a setting into the AIT whereby a Java program is started automatically at the time of reproducing a broadcast service but is not started automatically at the time of reproducing a recorded service.

For example, regarding Java programs for which startup is to prohibited when reproducing a broadcast service but for which automatic startup is to be performed when reproducing a recorded service, such a setup can be implemented through the broadcast station system specifying, at the time of sending, “kill” in the control information in column 2202 and “autostart” in the record time control information in column 2806 of the AIT.

In addition, regarding lava programs for which automatic startup is not to be performed when reproducing a broadcast service but for which automatic startup is to be performed when reproducing a recorded service, such a setup can be implemented through the broadcast station system specifying, at the time of sending, “present” in the control information in column 2202 and “autostart” in the record time control information in column 2806 of the AIT.

Finally, regarding Java programs which are to be started in both cases, such a setup can be implemented through the broadcast station system specifying, at the time of sending, “autostart” in the control information in column 2202 and “autostart” in the record time control information in column 2806 of the AIT.

### Third Embodiment

With the methods described in the first and second embodiments, adding a new field or a descriptor definition in the AIT is a prerequisite. In the present embodiment, it is possible to discriminate between various control modes by increasing the range which the value of the control information in column 2202 of the AIT can take on.

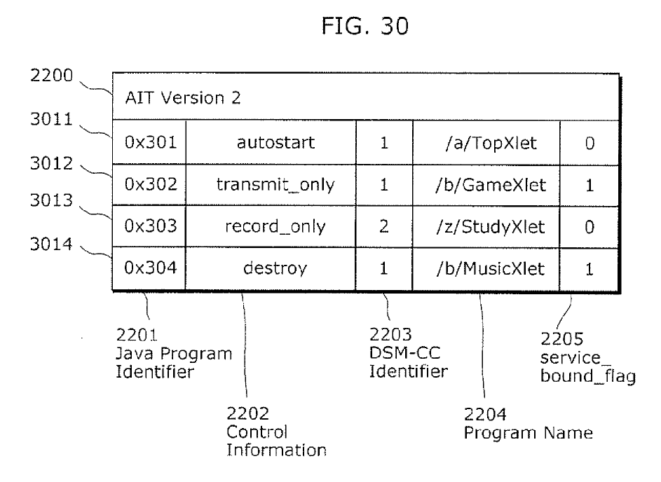

Hereafter, the AIT of the present embodiment is shown in FIG. 30. Items indicated by the same numbers as in FIG. 22 have already been described with reference to FIG. 22, and thus further descriptions shall be omitted. Column 3002 is control information. However, in the present embodiment, “record_only” and “transmit_only” are introduced into the range which the value of the control information can take on. “record_only” indicates that the Java program is started automatically only at the time of reproducing a recorded service. “transmit_only” indicates that the Java program is started automatically only at the time of reproducing a broadcast service. Rows 3011, 3012, 3013, and 3014 are groups of the information of the Java program. As an example, the Java program defined by row 3011 is a combination of the Java program identifier “0x3001”, the control information “autostart”, the DSM-CC identifier “1”, the program name “a/TopXlet”, and a service_bound_flag of “0”. In the same manner, the Java program defined in row 3012 is a group including a Java program identifier of “0x3002”, the control information “present”, a DSM-CC identifier of “1”, a program name of “b/GameXlet”, a service_bound_flag of “1”.

Hereafter, a method through which the application status management unit 2101 determines the Java program that is to start automatically when starting a service.

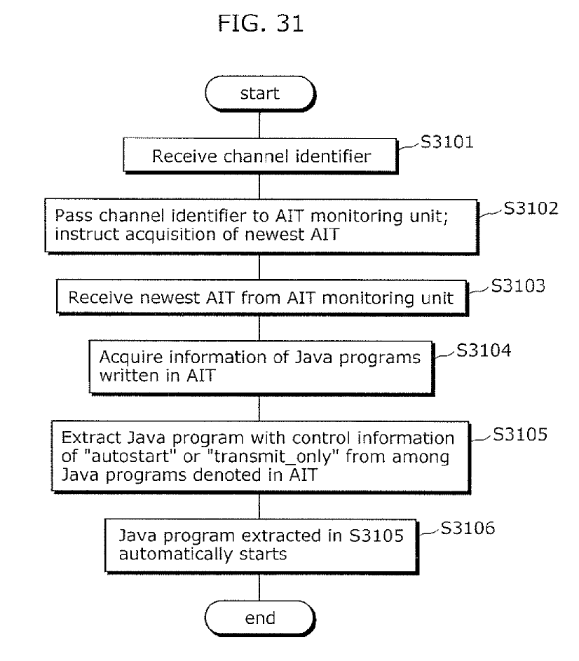

First, a method for determining the Java program to he started automatically when a “broadcast service” is reproduced shall so be described. FIG. 31 shows an operational sequence of the application status management unit 2101 when a broadcast service is reproduced. Upon being passed the channel identifier and being instructed to start the Java program included within the broadcast service (S3101), the application status management unit 2101 first passes the channel identifier to the AIT monitoring unit 2102 and provides the AIT monitoring unit 2102 with an instruction to start monitoring the AIT (53102). When the newest AIT is received from the AIT monitoring unit 2102 (53103), the AIT is analyzed and the Java program information acquired (S3104), the control information held in column 2202 is examined and the lava program with control information of “autostart” or “transmit only” is extracted (S3105). The Java program extracted in S3105 is considered to be a Java program to be started automatically when the “broadcast service” is reproduced, and is started through the process described earlier (S3106).

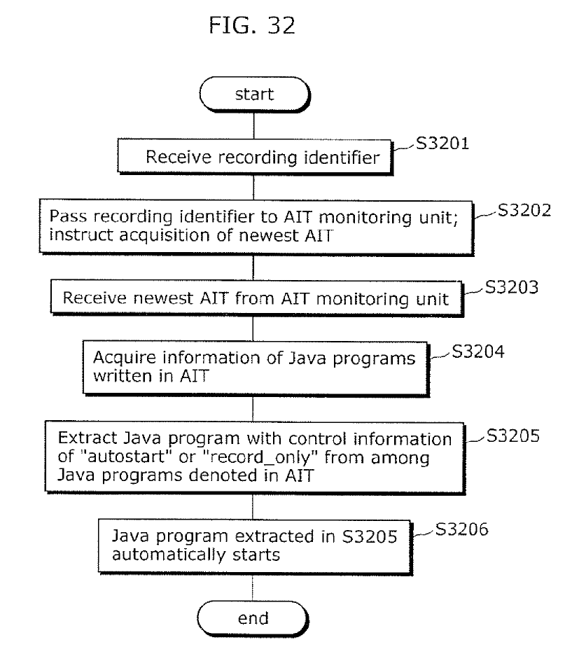

Next, a method for determining the Java program to be started automatically when a “recorded service” is reproduced shall be described. FIG. 32 shows an operational sequence of the application status management unit 2101 when a recorded service is reproduced. Upon being passed the recording identifier and being instructed to start the lava program included within the recorded service (S3201), the application status management unit 2101 first passes the recording identifier to the AIT monitoring unit 2102 and provides the AIT monitoring unit 2102 with an instruction to start monitoring the AIT (S3202). When the newest AIT is received from the AIT monitoring unit 2102 (S3203), the AIT is analyzed and the Java program information acquired (S3204), the control information held in column 2202 is examined and the Java program with control information of “autostart” or “record-only” is extracted (S3205). The Java program extracted in S3205 is considered to be a Java program to be started automatically when the recorded service is reproduced, and is started through the process described earlier (S3206).

With the method according to the present embodiment, the AM 1704b changes the method of selecting the Java program to start automatically depending on whether a broadcast service or a recorded service is specified; alternatively, the Java program to be automatically reproduced is changed. Particularly in the present embodiment, no new fields or descriptors are added to the AIT and thus the above implementation is possible with the size of the AIT remaining at a minimum.

For example, regarding Java programs for which startup is to be prohibited when reproducing a broadcast service but for which automatic startup is to be performed when reproducing a recorded service, such a setup can be implemented through the broadcast station system specifying, at the time of sending, “record_only” in the control information in column 3002 of the AIT.

In addition, regarding Java programs for which startup is to be performed when reproducing a broadcast service but for which startup is to be prohibited when reproducing a recorded service, such a setup can be implemented through the broadcast station system specifying, at the time of sending, “transmit_only” into he control information in column 3002 of the AIT.

Finally, regarding Java programs which are to be started in both cases, such a setup can be implemented through the broadcast station system specifying, at the time of sending, “autostart” in the control information in column 3002 of the AIT.

Note that in the present embodiment, the two values “record_only” and “transmit_only” have been added as values which the control information can take on; however, the system may use a configuration in which only one of those values is added. In the case where the former value is to be added, the operational sequence of the application status management unit 2101 is identical to that described in the present embodiment when a recorded service has been specified; however, when a broadcast service has been specified, only the control information of “autostart” is extracted in step S3105 of FIG. 31. In the case where the latter value is to be added, the operational sequence of the application status management unit 2101 is identical to that described in the present embodiment when a broadcast service has been specified; however, when a recorded service has been specified, only the control information of “autostart” is extracted in step S3205 of FIG. 32.

Furthermore, these two values have been added as an “autostart’ in which the Java program operates only in one of the two patterns,” the “patterns” referring to reproduction of a broadcast service and reproduction of a recorded service; however, values that, for example, implement “present’ in which the Java program operates only in one of the two patterns” may be added. When the above-described cases have been added, in the operational sequence of the application status management unit 2101 can be performed by altering the range of the control information extracted in steps S3105 and S3205 in FIGS. 31 and 32, in which a broadcast service and a recorded service are respectively specified, to include the added values.

(Variations)

The several embodiments described above indicate embodiments of the present invention, but other embodiments can be considered as long as the intent of the present invention is realized. In addition, a configuration may be one in which main processes of each embodiment are selected and combined.

In the embodiments, a configuration for a cable system has been shown, but the present invention can be applied independent of the type of broadcast system. For example, the present invention can easily be applied to a satellite system, a ground wave system, or a TV program distribution system that uses an IP network. In addition, as the present invention has no direct relationship with the differences between each broadcast system, the present invention can be applied to an arbitrary transmission medium regardless of the broadcast system. The present invention is also applicable regardless of whether the system is a wired or wireless a system.

It is not necessary for the AV decoder to decade video and audio at the same time. The present invention can be implemented even if the AV decoder is configured as separate video and audio decoders. In addition, the AV decoder may have a decode function for data such as closed captioning and the like without any interference. The audio signal and video signal decoded by the AV decoder may be scrambled at any stage up until being stored in the recording area 1504.

In the embodiments, an example is given in which an adapter that controls limited viewing has been introduced, but the adapter is not necessary for the implementation of the present invention. The adapter may be of any format, and a configuration without the adapter is also possible. In such a case, in FIG. 15, the MPEG-2 transport stream from the tuner is inputted directly into the TS decoder. The present invention is applicable is such a case as well. In addition, removal of the limited viewing by the adapter does not necessarily have to be carried out before the TS decoder. A configuration in which the adapter is in an arbitrary position and is used to remove the limited viewing is easily implementable, and the present invention is applicable in such a case as well. Also, the present invention is application even if an adapter that does not include scrarnbling/descrambling is used.

Regarding an encoding format into which the AV encoder encodes the audio and video signal, an arbitrary format is acceptable. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which performs multiple processes, the processes being all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU and pass the resultant to the CPU, which executes it; the present invention is applicable in such a case as well.

The above embodiments describe a method for implementation regarding the AIT in which the transport stream is obtained from in-band; however, the method for referring to the Java program which the AM shalt execute does not solely depend on the AIT. In OCAP, which is assumed as being used in United States cable systems, XAIT, which is identical to AIT and transmits synchronous data OOB, is used. In addition, methods such as starting a program pre-recorded in the ROM, starting a program downloaded and recorded in the secondary storage unit, and so on can be considered.

A method for recording the DCSM-CC file system and the AIT file may be an arbitrary method.

The present invention can be implemented even if a method in which the AIT section is filtered and acquired from the MPEG-2 transport stream and a method in which the DSN-CC section is recorded in a file in a unique format are combined. In addition, the present invention can be implemented even if a method in which the DSM-CC section is filtered and acquired from the MPEG-2 transport stream and a method in which the AIT section is recorded in a file in a unique format are combined. In the case where the AIT section is recorded in a file in a unique format, the AIT monitoring unit 2102 obtains information equivalent to the AIT from that file and notifies the application status management unit 2101.

A Java program is downloaded and executed in the present example; however, the Java program may be started from the secondary storage unit 1301 within the terminal rather than downloading it.

Note that the following hardware system is also possible: when recording a broadcast service, data may be scrambled using a unique scrambling process and then stored in the recording area 1504, and when reproducing the recorded service, a unique descrambling process is performed on the scrambled data before it is read out from the recording area 1504. In such a case, in FIG. 15, a scrambling device is provided in the multiplexer 1313, and scrambling is performed on the data inputted into the multiplexer 1313 prior to being stored in the recording area 1504. Furthermore, in FIG. 16, a descrambling device is provided, descrambling somewhere before the data read out from the recording area 1504 reaches the AV decoder 1303, the section filter 1503, and so on This type of descrambling setup can be implemented using publicly-known technology, and the present invention is applicable regardless of whether or not this scrambling/descrambling is performed.

With the present invention, by including, in a broadcast receiving apparatus which receives a digital broadcast, a content reproduction unit operable to reproduce content; a storage area in which content included in a broadcast signal is stored; a content recording unit operable to record the content included in a broadcast signal into said storage area; an application extraction unit operable extract an application included in the content reproduced by said content reproduction unit; an application startup signal extraction unit operable to extract an application startup signal and a recorded content application startup flag which are included in the content reproduced by said content reproduction unit; and an application startup unit operable to start the application extracted by said application extraction unit when said content reproduction unit reproduces the content, it is possible to perform control so that in the case where the content is included in a broadcast signal, said application startup unit is operable to automatically start up the application only when the application startup signal extracted by said application startup signal extraction unit indicates “automatic execution”, and in the case where the content is reproduced from said storage area, the application is automatically started when the application startup signal extracted by said application startup signal extraction unit indicates “automatic execution” or when the recorded content application startup flag extracted by said application startup signal extraction unit indicates “true”.

By including, in a broadcast receiving apparatus which receives a digital broadcast, a content reproduction unit operable to reproduce content; a storage area in which content included in a broadcast signal is stored; a content recording unit operable to record the content included in a broadcast signal into said storage area; an application extraction unit operable to extract an application included in the content reproduced by said content reproduction unit; an application startup signal extraction unit operable to extract an application startup signal and a recorded content application startup signal which are included in the content reproduced by said content reproduction unit; and an application startup unit operable to start the application extracted by said application extraction unit when said content reproduction unit reproduces the content, it is possible to perform control so that in the case where the content is included in a broadcast signal, said application startup unit is operable to automatically start up the application only when the application startup signal extracted by said application startup signal extraction unit indicates “automatic execution”, and in the case where the content is reproduced from said storage area, the application is automatically started only when the recorded content application startup signal extracted by said application startup signal extraction unit indicates “automatic execution”.

By including, in a broadcast receiving apparatus which receives a digital broadcast, a content reproduction unit operable to reproduce content; a storage area in which content included in a broadcast signal is stored; a content recording unit operable to record the content included in a broadcast signal into said storage area; an application extraction unit operable to extract an application included in the content reproduced by said content reproduction unit; an application startup signal extraction unit operable to extract an application startup signal which is included in the content reproduced by said content reproduction unit; and an application startup unit operable to start the application extracted by said application extraction unit when said content reproduction unit reproduces the content, it is possible to perform control so that in the case where the content is included in a broadcast signal, said application startup unit is operable to automatically start up the application only when the application startup signal extracted by said application startup signal extraction unit indicates “automatic execution” or “execute only when reproducing broadcast signal”, and in the case where the content is reproduced from said storage area, the application is automatically started only when the application startup signal extracted by said application startup signal extraction unit indicates “automatic execution” or “execute only when reproducing broadcast signal”.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A recording and reproduction apparatus and recording and reproduction method according to the present invention can be applied in the consumer electronics industry as an apparatus for recording and reproducing a broadcast. For example, the present invention is applicable to cable STB, digital TV, and the like. Furthermore, the present invention is also applicable in devices with a broadcast receiving function, such as, for example, a cellular phone device and the like.

What is claimed is:

1. A broadcast receiving apparatus comprising:
a receiving unit operable to receive a broadcast signal that includes a broadcast service, the broadcast service including video and audio information, an application program, and control information for controlling startup of the application program;
a video and audio reproduction unit operable to reproduce the video and audio information included in the broadcast service;
an application extraction unit operable to extract the application program, the application program being executed in synchronization with the video and audio information reproduced by said video and audio reproduction unit;
an application execution unit operable to execute the application program included in the broadcast service in accordance with the control information included in the broadcast service;
a secondary storage unit which has an area that stores information even when the power source to said broadcast receiving apparatus is cut off; and
a recording unit operable to record the broadcast service including the video and audio information and application program into said secondary storage unit,
wherein said control information includes first control information for controlling startup of the application program at the time of broadcasting, and second control information for controlling, after the application program has been recorded into said secondary storage unit, startup of the recorded application program;
said application execution unit is operable to control startup of the application program associated with the first control information in accordance with the first control information, at the time of broadcasting; and
said application execution unit is operable to control startup of the application program in accordance with the second control information associated with the application program, in the case of executing an application program that has been recorded into said secondary storage unit.

2. The broadcast receiving apparatus according to claim 1,
wherein, during reproduction by said video and audio reproduction unit, in the case where said application extraction unit extracts the application program recorded into said secondary storage unit, said application extraction unit is operable to extract the application program for which the second control information, which is included in the control information recorded into said secondary storage unit, indicates the application is to be started automatically.

3. The broadcast receiving apparatus according to claim 1,
wherein, during reproduction by said video and audio reproduction unit, in the case where said application extraction unit extracts the application program recorded into said secondary storage unit, said application extraction unit is operable to extract the application program for which the second control information and the first control information, which are included in the control information recorded into said secondary storage unit, indicate the application is to be started automatically.
